(19) United States
(12) Patent Application Publication
(10) Pub. No.: US 2020/0199020 A1
(43) Pub. Date: Jun. 25, 2020

(54) COVER MEMBER AND PORTABLE INFORMATION TERMINAL

(71) Applicant: AGC Inc., Chiyoda-ku (JP)

(72) Inventors: Maya HATANO, Tokyo (JP); Satoshi Kanasugi, Tokyo (JP); Masao Ozeki, Tokyo (JP)

(73) Assignee: AGC Inc., Chiyoda-ku (JP)

(21) Appl. No.: 16/807,240

(22) Filed: Mar. 3, 2020

Related U.S. Application Data
(63) Continuation of application No. PCT/JP2018/033111, filed on Sep. 6, 2018.

(30) Foreign Application Priority Data
Sep. 11, 2017 (JP) 2017-173852

(51) Int. Cl. C03C 21/00

(52) U.S. Cl. CPC C03C 21/002; G06F 1/1637

(57) ABSTRACT

The present invention relates to a cover member (1) made of chemically strengthened glass for protecting an object to be protected, the cover member (1) being characterized by: at least one recessed part (7) being provided on at least one of a first main surface (3) and a second main surface (5) of the cover member (1); the cover member (1) integrally comprising a thin part (13) formed by the recessed part and a thick part (17) connecting with the thin part (13); and, defining tensile stress as positive and compressive stress as negative, the integral value S for main stress difference in the through-thickness direction of the thin part (13) at the position of the center of gravity of the thin part being less than 0 MPa.

### TECHNICAL FIELD

The present invention relates to a cover member and a personal data assistance.

### BACKGROUND ART

In recent years, a method that a fingerprint is used for personal authentication has come to be employed broadly as a high-level security measure in electronic devices. Examples of fingerprint authentication methods include an optical method, a heat-sensitive method, a pressure method, a capacitance method, and an ultrasonic method. It is a common understanding that among these methods the capacitance method and the ultrasonic method are superior from the viewpoints of the sensitivity of sensing and power consumption.

Capacitive sensors detect a local capacitance change of a portion to which a target object has come closer, or a portion with which a target object has come into contact. Common capacitive sensors measure distances between a target object and electrodes provided in the sensor on the basis of magnitudes of capacitances. Ultrasonic sensors can detect a target object three-dimensionally by using ultrasonic waves. Sensors of these kinds are expected to be used as biometrics authentication sensors that provide increased security because they can perform detection with transmission through a foreign substance such as liquid. A fingerprint authentication function using any of these sensors is employed particularly in personal data assistance (Personal Data Assistance: PDA) such as smartphones, cellphones, and tablet personal computers because it enables size and weight reduction and low power consumption. Usually, to protect the fingerprint authentication sensor (which may be referred to simply as a “sensor” below), the top surface thereof is provided with a cover member.

Patent literature 1 discloses a structure of a cover member for a portable device in which a major surface of the cover member is formed with a recess for allowing a user to recognize characters or a figure.

Patent literature 1 describes the effect that a desired surface compressive stress CS, internal tensile stress CT, and depth of compressive stress layer DOL are obtained by chemically strengthening the cover member.

Patent literature 2 discloses a structure of a cover member for a portable device in which the front surface and the back surface of the cover member are formed with respective recesses to form a thin portion there.

Patent literature 2 describes the effect that a desired surface compressive stress CS, internal tensile stress CT, and depth of compressive stress layer DOL are obtained by chemically strengthening the cover member.

### CITATION LIST

### Patent Literature

Patent literature 1: JP-A-2017-1940

Patent literature 2: JP-A-2017-48090

### SUMMARY OF INVENTION

### Technical Problem

In cover members having a thin portion and a thick portion, there may occur a case that the thin portion and the thick portion are different from each other in the strength required. Thus, in Patent literatures 1 and 2, the thin portion and the thick portion are given desired strength values by obtaining surface compressive stress CS, internal tensile stress CT, and depth of compressive stress layer DOL which are different values in the thin portion and the thick portion.

Where the thickness is constant, since the surface compressive stress CS, internal tensile stress CT, and depth of compressive stress layer DOL indicate the degree of strengthening of glass, they are effective indices for expressing the glass strength.

However, since CT that greatly influence the fracture characteristic of glass is calculated using CS, DOL, and a thickness, CT cannot be expressed uniformly in the case where the thickness has a distribution.

In particular, since a thin portion is thinner than a thick portion and needs to be subjected to stricter strength designing, if strength designing is performed using an improper index, a problem due to insufficient strength such as fracture more likely occurs in the thin portion than in the thick portion.

An object of the present invention is to provide a cover member in which one or both of its thin portion and thick portion have necessary strength, and to provide a personal data assistance.

### Solution to Problem

The cover member according to the present invention is a cover member which serves to protect a protection target and includes a chemically strengthened glass, integrally including:

a first major surface and a second major surface;

at least one recess formed in at least one of the first major surface and the second major surface; and

a thin portion formed by the recess, and a thick portion connected to the thin portion, in which the cover member has an integral value S of a principal stress difference being smaller than 0 MPa in a thickness direction of the thin portion at a center of gravity of the thin portion, in a case where a tensile stress and a compressive stress are regarded as positive and negative, respectively.

In the present invention, compressive stress occurs in the thin portion because the integral value S of the principal stress difference in the thickness direction of the thin portion is smaller than 0 MPa.

As a result, even if the thickness of the thin portion is small, the thin portion is less likely to break against impact and has necessary strength. Furthermore, since the integral value S of the principal stress difference in the thickness direction is a strength value which reflects the stress of the entire thin portion in its thickness direction, the stress of the entire thin portion can be evaluated using a single index.

According to one mode of the present invention, it is preferable that the integral value S of the principal stress difference in the thickness direction of the thin portion is smaller than −10 MPa.

According to this mode, since the integral value S of the principal stress difference in the thickness direction of the thin portion is smaller than −10 MPa, a larger compressing stress occurs in the thin portion.

As a result, even if the thickness of the thin portion is small, the thin portion is even less prone to break and has necessary strength.

According to one mode of the present invention, it is preferable that the thick portion has a surface compressive stress CS of larger than a surface compressive stress CS in the thin portion; and the thin portion has a thickness of smaller than or equal to ½ of a thickness of the thick portion.

According to this mode, since the surface compressive stress CS in the thick portion is larger than the surface compressive stress CS in the thin portion, the thick portion is less likely to break when the cover member receives impact due to a drop or the like. Since the thickness of the thin portion is smaller than or equal to ½ of the thickness of the thick portion, it is easier to make the integral value S of the principal stress difference in the thickness direction small.

According to one mode of the present invention, it is preferable that each of the surface compressive stress CS in the thin portion and the surface compressive stress CS in the thick portion is 300 MPa or larger.

According to this mode, since each of the surface compressive stress CS in the thin portion and the surface compressive stress CS in the thick portion is 300 MPa or larger, both of the thin portion and the thick portion are less likely to break when the cover member receives impact due to a drop or the like.

According to one mode of the present invention, it is preferable that the thin portion has an internal tensile stress CT of larger than an internal tensile stress CT in the thick portion.

According to this mode, since the internal tensile stress CT in the thin portion is larger than the internal tensile stress CT in the thick portion, when the cover member receives an unexpectedly strong impact, the thin portion breaks first and absorbs the impact to prevent breaking of the thick portion.

Thus, this mode is advantageous when it is desired to protect the thick portion with priority over the thin portion.

According to one mode of the present invention, where the internal tensile stress CT in the thin portion is larger than the internal tensile stress CT in the thick portion, it is preferable that the internal tensile stress CT in the thin portion is 50 MPa or larger and the internal tensile stress CT in the thick portion is 50 MPa or smaller.

According to this mode, since the internal tensile stress CT in the thin portion is 50 MPa or larger and the internal tensile stress CT in the thick portion is 50 MPa or smaller, this cover member is more suitable for use as, for example, a cover glass of a smartphone in which it is desired to suppress breaking of the thick portion.

According to one mode of the present invention, it is preferable that the thick portion has the internal tensile stress CT of larger than the internal tensile stress CT in the thin portion.

According to this mode, since the internal tensile stress CT in the thick portion is larger than the internal tensile stress CT in the thin portion, when the cover member receives an unexpectedly strong impact, the thick portion breaks first and absorbs the impact to prevent breaking of the thin portion.

Thus, this mode is advantageous when it is desired to protect the thin portion with priority over the thick portion.

According to one mode of the present invention, where the internal tensile stress CT in the thick portion is larger than the internal tensile stress CT in the thin portion, it is preferable that the internal tensile stress CT in the thick portion is 50 MPa or larger and the internal tensile stress CT in the thin portion is 50 MPa or smaller.

According to this mode, since the internal tensile stress CT in the thick portion is 50 MPa or larger and the internal tensile stress CT in the thin portion is 50 MPa or smaller, this cover member is more suitable for use as, for example, a cover glass of a known entrance/exit management system using fingerprint authentication.

According to one mode of the present invention, it is preferable that the thin portion has the internal tensile stress CT of smaller than 0 MPa at an arbitrary point in a cross section of the thin portion.

According to this mode, since the stress at an arbitrary point of the thin portion is 0 MPa or smaller, compressive stress occurs at the arbitrary position of the thin portion in the thickness direction.

As a result, even if the thickness of the thin portion is small, the thin portion is even less prone to break and has necessary strength.

According to one mode of the present invention, at least a part of the thick portion may have a bent portion.

According to this mode, since at least a part of the thick portion has a bent portion, the present invention can also be applied to a three-dimensional glass or the like.

According to one mode of the present invention, at least a part of the thick portion may have a through-hole.

According to this mode, since at least a part of the thick portion has a through-hole, even in a case where a connector for connection to the outside, such as an earphone jack is exposed from a protection target surface to which the cover member is to be attached, the cover member can be attached to the protection target surface without covering the connector.

According to one mode of the present invention, the protection target may be a personal data assistance.

According to this mode, since the thin portion of the cover member has necessary strength, the personal data assistance can be protected even in the case where the thin portion is located on an input portion or a display screen of the personal data assistance.

The personal data assistance according to the present invention is characterized by comprising one of the above cover members.

The present invention can provide a personal data assistance that is protected by a cover member.

### BRIEF DESCRIPTION OF DRAWINGS

FIG. 1 (A) of FIG. 1 and (B) of FIG. 1 are views of a cover member; (A) of FIG. 1 is a sectional view and (B) of FIG. 1 is a sectional view taken along an arrowed line II-II in (A) of FIG. 1.

FIG. 2 (A) of FIG. 2 is a sectional view taken along line in (B) of FIG. 1, and (B) of FIG. 2 is a plan view of a recess as viewed from the Z direction.

FIG. 3 is a sectional view of a cover member in which a sensor is disposed.

FIG. 4 (A) of FIG. 4 is a sectional view of a cover member in which a recess is formed in a first major surface, (B) of FIG. 4 is a plan view of the recess as viewed from the Z direction.

FIG. 5 is a sectional view of the cover member on which a sensor is disposed.

FIG. 6 is a sectional view of a cover member in which the recess is formed with a projected portion.

FIG. 7 is a plan view of a glass substrate.

FIG. 8 (A) of FIG. 8 is an enlarged view of part IX in FIG. 7 and (B) of FIG. 8 is an enlarged view of part X in FIG. 7.

FIG. 9 (A) of FIG. 9 is a plan view of a glass member and (B) of FIG. 9 is a plan view of the glass member in which recesses are formed.

FIG. 10 (A) of FIG. 10 is a plan view of a first mask member and (B) of FIG. 10 is a plan view of a second mask member.

FIG. 11 (A) of FIG. 11 is a plan view of a first mask member according to a modification and (B) of FIG. 11 is a plan view of a glass substrate according to the modification.

FIG. 12 is a plan view of a glass substrate according to a modification.

FIG. 13 (A) of FIG. 13 is a sectional view of a cover member that is incorporated in a body, and (B) of FIG. 13 is a sectional view of a cover member that is incorporated in a body and shows a structure in which a cover member 1 is formed with a recess 7A.

FIG. 14 is a plan view of a cover member on which an antiglare treatment layer is formed.

FIG. 15 (A) of FIG. 15 and (B) of FIG. 15 are XXI-XXI sectional views of FIG. 14.

FIG. 16 is a plan view of a cover member according to a modification on which an antiglare treatment layer is formed.

FIG. 17 (A) of FIG. 17 and (B) of FIG. 17 are XXIII-XXIII sectional views of FIG. 16.

FIG. 18 (A) to (D) of FIG. 18 are sectional views of cover members on which an antifouling layer is formed.

FIG. 19 (A) to (D) of FIG. 19 are sectional views of cover members according to modifications on which an antifouling layer is formed.

FIG. 20 (A) of FIG. 20 and (B) of FIG. 20 are sectional views of cover members according to modifications on which an antifouling layer is formed.

FIG. 21 is a sectional view of a cover member on which a printed layer is formed.

FIG. 22 is a sectional view of a cover member on which a printed layer is formed.

FIG. 23 is a sectional view of a cover member on which a printed layer is formed.

FIG. 24 (A) of FIG. 24 and (B) of FIG. 24 are graphs showing relationships between the chemical strengthening time and the integral value S of the principal stress difference in the thickness direction in Examples 1 and 2, respectively.

FIG. 25 (A) of FIG. 25 and (B) of FIG. 25 are graphs showing relationships between the chemical strengthening time and the integral value S of the principal stress difference in the thickness direction in Examples 3 and 4, respectively.

FIG. 26 (A) of FIG. 26 and (B) of FIG. 26 are graphs showing relationships between the chemical strengthening time and the surface compressive stress CS in Examples 1 and 2, respectively.

FIG. 27 (A) of FIG. 27 and (B) of FIG. 27 are graphs showing relationships between the chemical strengthening time and the surface compressive stress CS in Examples 3 and 4, respectively.

FIG. 28 (A) of FIG. 28 and (B) of FIG. 28 are graphs showing relationships between the chemical strengthening time and the internal tensile stress CT in Examples 1 and 2, respectively.

FIG. 29 (A) of FIG. 29 and (B) of FIG. 29 are graphs showing relationships between the chemical strengthening time and the internal tensile stress CT in Examples 3 and 4, respectively.

FIG. 30 is a sectional view of a cover member having a bent portion.

FIG. 31 is a sectional view of a cover member having a through-hole.

FIG. 32 is a sectional view of a cover member having recesses formed on both surfaces thereof.

### DESCRIPTION OF EMBODIMENTS

Although an embodiment of the present invention will be hereinafter described, the present invention is not limited to the following embodiment. Various modifications, replacements, etc. can be employed in the following embodiment without departing from the scope of the present invention.

### (Structure of Cover Member)

A cover member according to the present embodiment includes chemically strengthened glass and is used for protecting any protection target. Although the following description will be made with an assumption that the protection target of the cover member is a personal data assistance such as a smartphone, the protection target may be any target. For example, the cover member according to the embodiment can be applied to display devices that are combined with a display panel such as a liquid crystal panel or an EL panel. In particular, the cover member according to the embodiment is superior when used as a large-size cover member for a vehicular display.

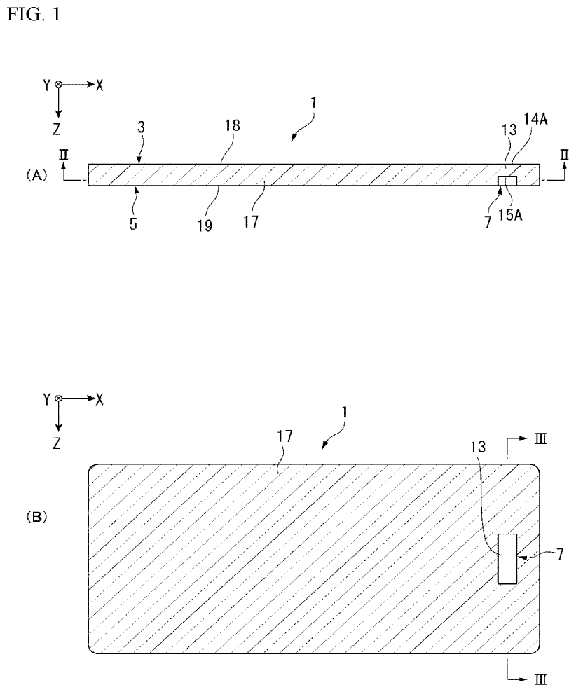

As shown in (A) of FIG. 1 and (B) of FIG. 1, the cover member 1 according to the present embodiment is flat as a whole and includes a first major surface 3 as shown in upper side of FIG. 1 and a second major surface 5 facing the first major surface 3, as shown in lower side of FIG. 1. In the present description, the first major surface 3 is an outside surface of an assembly including the cover member 1, that is, a surface that is touched by a user in an ordinary use state. The second major surface 5 is an inside surface of an assembly, that is, a surface that is not touched by the user in an ordinary use state. In the following description, the X direction, Y direction, and Z direction are defined as the longitudinal direction, short direction, and thickness direction of the cover member 1, respectively. Alternatively, the first major surface 3 may be the surface that is not touched by the user and the second major surface 5 may be the surface that is touched by the user.

At least one of the first major surface 3 and the second major surface 5 of the cover member 1 is formed with at least one recess 7. (A) of FIG. 1 and (B) of FIG. 1 show an example in which the second major surface 5 of the cover member 1 is formed with one recess 7. The recess 7 is formed in the vicinity of an end in the X direction of the cover member 1 and in center in the Y direction. The recess 7 may be set at any position in the first major surface 3 or the second major surface 5 of the cover member 1. And any number of recesses 7 may be formed.

Since the recess 7 is formed in the above-described manner, a thin portion 13 is formed at the same position as the position where the recess 7 is formed, and a thick portion 17 that is connected to the circumference of the thin portion 13 and is thicker than the thin portion 13 in the Z direction is formed.

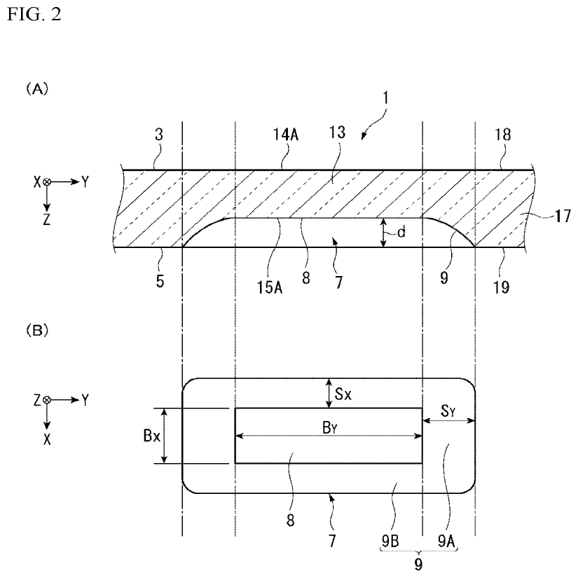

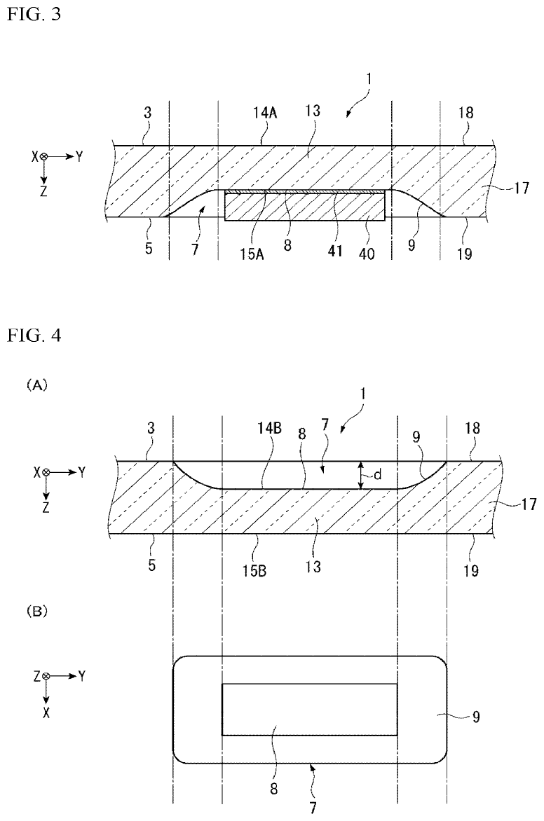

(A) of FIG. 2 and (B) of FIG. 2 show the shape of the recess 7 more specifically. As shown in (B) of FIG. 2, when viewed from the Z direction, the recess 7 has an approximately rectangular shape having shorter sides extending in the X direction and longer sides extending in the Y direction. The recess 7 also has an approximately flat bottom surface 8 and a side surface 9 that is connected to the circumference of the bottom surface 8. The side surface 9 has a curved surface shape (R shape) connected to the bottom surface 8 smoothly. The side surface 9 constitutes a region that surrounds the bottom surface 8. More specifically, the side surface 9 occupies a region that extends from the boundary between a region in the vicinity of the bottom surface 8 where the radius of curvature is longer than 2 mm and a region where the radius of curvature is 2 mm or shorter, to the circumference of the recess 7. In this case, the radius of curvature of the side surface 9 decreases as the position goes from the center of the recess 7 to its circumference. With this structure, the stress concentration at the connection portion of the bottom surface 8 and the side surface 9 is lowered and the strength is increased. In particular, in the case where a sensor 40 for fingerprint authentication is disposed in the recess 7 (see FIG. 3), a finger is pressed against the thin portion 13 every time of authentication and hence force is applied on the above-described connection portion repeatedly. This shape provides an advantage of preventing stress concentration on that portion.

The radius of curvature of a side surface 9 shown in FIG. 3 increases as the position goes from the center of a recess 7 to its circumference. That is, the side surface 9 is a curved surface that becomes gentler as the position goes outward in the X direction and the Y direction.

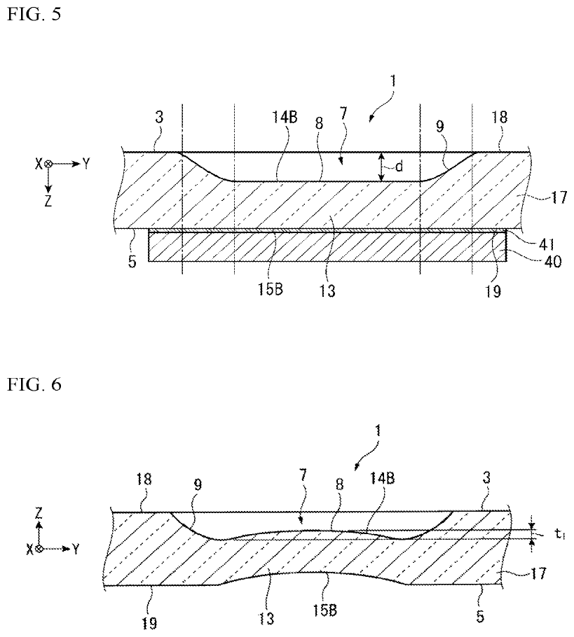

In a case that a first major surface 3 of a cover member 1 is formed with a recess 7 and a sensor 40 for fingerprint authentication is disposed on a corresponding portion of a second major surface 5 (see FIG. 5), if the radius of curvature of a side surface 9 is made the same as shown in FIG. 3, the ease of finger insertion into the recess 7 is increased and a central portion of a fingertip can be guided to a bottom surface 8 of the recess 7 spontaneously.

The radius of curvature of the side surface 9 varies depending on the position but the radius of curvature is set longer than or equal to the depth d of the bottom surface 8 at every position. With this structure, the ease of finger insertion into the recess 7 is increased and a central portion of a fingertip can be guided to the bottom surface 8 of the recess 7 spontaneously. More specifically, the radius of curvature of the side surface 9 is preferably 0.1 mm or longer and 2 mm or shorter, and even preferably 0.2 mm or longer and 1 mm or shorter. Where the radius of curvature of the side surface 9 is 0.1 mm or longer, a strength increasing effect by relaxation of stress concentration is exerted. Where the radius of curvature of the side surface 9 is 2 mm or shorter, working in an etching process which will be described later is made easier. If the workability in one time of etching process which will be described later is taken into consideration, it is preferable that the radius of curvature of the side surface 9 is shorter than three times, even preferably shorter than two times, with respect to the depth d of the recess 7.

It is preferable that as shown in FIG. 3 the connection portion of the side surface 9 and the second major surface 5 have a curved surface shape that connects the side surface and the second major surface smoothly. Where this connection portion has a curved surface shape having no edges, the cover member is less prone to be chipped or damaged when it drops or comes into contact with an external member. To make the connection portion of the side surface 9 and the second major surface 5 be a curved surface shape that connects them smoothly, the connection portion is finished by buff polishing or the like after formation of the recess 7. However, where the recess 7 is formed by wet etching, the connection portion can be made to be a curved surface shape that connects the side surface 9 and the second major surface 5 smoothly by removing the glass substrate from the etchant after the etching process and leaving the glass substrate as it is for a longer time than usual before mask peeling and cleaning. When etchant remains in a boundary portion between the side surface 9 of the recess 7 and the mask because of surface tension, etching proceeds slightly in a connection portion, adjacent to the remaining etchant, of the side surface 9 and the second major surface 5 and hence the edge of the connection portion is made to be a smooth, continuous curved surface. The holding time for this purpose is adjusted so as to be in a range of several seconds to several tens of minutes depending on the etchant and the etching resistance of the glass substrate.

When the cover member 1 as described above is incorporated into a body or the like to protect any surface(s) required to be protected (e.g., front surface or side surfaces) of a personal data assistance or a display device, any of various devices such as a sensor for, for example, fingerprint authentication, a display panel such as a liquid crystal panel or an organic EL panel, an illumination device or a camera can be disposed on the back surface of the thin portion 13. Thus, the space utilization efficiency can be increased. Examples of the sensors include a biometrics authentication sensor using a fingerprint, an iris, a vein pattern, or the like. As a sensing method, sensors that employ a capacitive sensing method, optical sensing method, infrared sensing method, or ultrasonic sensing method are known. Other kinds of sensors are illuminance sensor, a temperature sensor, etc. Since the device attached to the back surface of the thin portion 13 is protected by the thin portion 13 which is opposed to the device in the Z direction, a cover member 1 can be realized that is uniform in material and high in sense of unity and is thus superior in design, without use of a sensor cover or the like made of a different material. Furthermore, this structure is very effective in cost reduction because the number of members used is small and the assembling process can be simplified. Still further, since the number of openings of the cover member 1 for incorporation of other members can be reduced, waterproofness and drip-proofness can be attained easily.

In the thin portion 13, an integral value S of the principal stress difference in the thickness direction at the center of gravity of the thin portion is smaller than 0 MPa, in which tensile stress and compressive stress are regarded as positive and negative, respectively. In the following description, an integral value S of the principal stress difference in the thickness direction may be abbreviated simply as an “integral value S.”

When the integral value S of the principal stress difference in the thickness direction of the thin portion 13 is smaller than 0 MPa, compressive stress occurs in the thin portion 13. As a result, even if the thickness of the thin portion 13 is small, the thin portion 13 is less likely to break against impact and has necessary strength.

As a result, even if the thickness of the thin portion 13 is small, the thin portion 13 is less likely to break against impact and has necessary strength. Furthermore, since the integral value S of the principal stress difference in the thickness direction represents strength that reflects stress in the entire thin portion 13 in the thickness direction, the strength in the entire thin portion 13 can be evaluated using a single index.

It is even preferable that the integral value S of the principal stress difference in the thickness direction of the thin portion 13 is smaller than −10 MPa because a stronger compressive stress occurs in the thin portion 13. It is further preferable that the integral value S of the principal stress difference in the thickness direction of the thin portion 13 is smaller than −20 MPa.

The integral value S of the principal stress difference in the thickness direction is a value obtained by determining a phase difference R with a phase difference evaluation instrument such as WPA100 of Photonic Lattice, Inc. and converting it into an S value according to the following equation:

S=(phase difference R)/(photoelastic constant C of glass).

The measurement position is the center of gravity of the thin portion 13. Since the phase difference R and the photoelastic constant C have a relationship R/C=σt where σ is the internal stress (more correctly, principal stress difference) and t is the thickness. The term “integral value S” as used in this application corresponds to at which corresponds to an integral value of the internal stress.

One specific method for making the integral value S smaller than 0 MPa is to perform chemical strengthening after making the thin portion 13 as thin as possible. It is preferable to set the chemical strengthening time long. Another method is to chemically strengthen the thin portion 13 selectively.

In addition to the feature that the integral value S in the thin portion 13 is smaller than 0 MPa, it is preferable that the cover member 1 has the internal tensile stress CT of smaller than 0 MPa at an arbitrary point in a cross section of the thin portion 13.

If the internal tensile stress CT at an arbitrary point in a cross section of the thin portion 13 is smaller than 0 MPa, compressive stress occurs at an arbitrary position in the thickness direction of the thin portion 13.

Thus, even if the thickness of the thin portion 13 is small, the thin portion 13 is less likely to break against impact and has necessary strength.

One specific method for making the internal tensile stress CT smaller than 0 MPa at an arbitrary point of the thin portion 13 is to perform chemical strengthening after making the thin portion 13 even thinner. It is preferable to set the chemical strengthening time long. Another method is to chemically strengthen the thin portion selectively.

It is preferable to form the recess 7 by etching though it can also be formed by mechanical working such as grinding or a shaping process such as hot pressing or vacuum shaping. Where etching is employed, minute scratches and faults are eliminated, whereby the cover member 1 is increased in strength. In the case of etching, the thickness of the thin portion 13 in the Z direction can be controlled easily and the process is completed by one step.

Where the recess 7 is formed in the second major surface 5 of the cover member 1 as in the present embodiment, the arithmetic mean roughness Ra of a flat-portion-side surface 14A of the thin portion 13 is preferably 50 nm or smaller, even preferably 45 nm or smaller, and further preferably 30 nm or smaller. Where the recess 7 is formed in the second major surface 5, the sensor 40 is disposed in the recess 7 (on a recess-side surface 15A of the thin portion 13) via an adhesive layer 41 in the manner shown in FIG. 3 and detects a target object such as a finger being in contact with the flat-portion-side surface 14A of the thin portion 13. Thus, the arithmetic mean roughness Ra of the flat-portion-side surface 14A of the thin portion 13 being 50 nm or smaller is preferable because a degree of unevenness of the flat-portion-side surface is sufficiently smaller than that of the fingerprint of a finger and hence the sensitivity of sensing is made high. Furthermore, in this structure, since the entire first major surface 3 of the cover member 1 is flat, the cover member is much superior in appearance. Although there are no particular limitations on the lower limit of the arithmetic mean roughness Ra of the flat-portion-side surface 14A of the thin portion 13, the arithmetic mean roughness Ra is preferably 2 nm or larger, even preferably 4 nm or larger. The arithmetic mean roughness Ra of the flat-portion-side surface 14A of the thin portion 13 can be adjusted by selection of abrasive grains, a polishing method, or the like.

The arithmetic mean roughness Ra can be measured according to the Japanese Industrial Standard JIS B0601: 2013.

As shown in FIG. 4, the recess 7 may be formed in the first major surface 3 of the cover member 1. Also in this case, the arithmetic mean roughness Ra of a recess-side surface 14B of the thin portion 13, in particular, of the bottom surface 8 of the recess 7, is preferably 50 nm or smaller, even preferably 45 nm or smaller, and further preferably 30 nm or smaller. In the structure in which the recess 7 is formed in the first major surface 3, the sensor 40 is disposed on the second major surface 5 of the cover member 1 at a position opposed to the recess 7 in the Z direction as shown in FIG. 5, that is, on a flat-portion-side surface 15B of the thin portion 13. The sensor 40 is disposed on the second major surface 5 of the cover member 1 via an adhesive layer 41. The adhesive layer 41 need not be formed in the case where the sensor 40 is fixed to a body or the like. Unlike the case of FIG. 3, since the sensor 40 is not disposed in the recess 7, the dimension of the sensor 40 can be made longer than the dimension of the recess 7 in at least one of the X, Y, and Z directions. Thus, the thin portion 13 can be reinforced by disposing a sensor having a relatively large dimension on the flat-portion-side surface 15B of the thin portion 13. The sensor 40 detects a target object being in contact with the recess-side surface 14B of the thin portion 13, in particular, with the bottom surface 8 of the recess 7. The arithmetic mean roughness Ra of the bottom surface 8 of the recess 7 being 50 nm or smaller is preferable because a degree of unevenness of the bottom surface is sufficiently smaller than that of the fingerprint of a finger and hence the sensitivity of sensing is made high in the case where the sensor 40 is of a capacitance type. Furthermore, in this structure, a user of a personal data assistance can more easily recognize the position of the thin portion 13 and the position of the sensor 40 disposed on the flat-portion-side surface 15B of the thin portion 13 by visual sensation, tactile sensation, or the like owing to the recess 7. Although there are no particular limitations on the lower limit of the arithmetic mean roughness Ra of the bottom surface 8 of the recess 7, the arithmetic mean roughness is preferably 2 nm or larger, even preferably 4 nm or larger. The arithmetic mean roughness Ra of the bottom surface 8 of the recess 7 can be adjusted by, for example, etching conditions that are employed in forming the recess 7.

Preferable forms of the cover member 1 will be described below by reference to the example structure shown in FIGS. 1 and 2. The same can be applied to the structure shown in FIGS. 3 and 4.

The haze value of the thin portion 13 is preferably 8% or smaller, even preferably 7% or smaller. Setting the haze value of the thin portion 13 being 8% or smaller makes it possible to satisfy the flatness of the thin portion 13 and appearance of the cover member 1. More specifically, since the haze value of the thin portion 13 is 8% or smaller and flatness is high, a desired sensing ability can be realized even in the case where a fingerprint authentication sensor is disposed at a position corresponding to the recess 7.

The flatness of the thin portion 13 influences the flatness of a printed layer that is printed on the recess-side surface 15A of the thin portion 13. Setting the haze value of the thin portion 13 at 8% or smaller makes it possible to secure a level of flatness that does not affect the sensor sensitivity and to make the appearance of the printed layer excellent. On the other hand, if the haze value of the thin portion 13 is larger than 8%, an ink that was used for the printing does not properly enter into unevenness of a bottommost layer of the thin portion 13, thereby lowering the appearance after mounting the cover member 1 on a protection target.

By setting the haze value of the thin portion 13 at 8% or smaller and thereby increasing transmittance of the thin portion 13, a cover member can be realized that has sense of unity between thin portion 13 and the thick portion 17 and is good in appearance as a whole.

The haze value of the thick portion 17 is preferably 1% or smaller, even preferably 0.5% or smaller, and further preferably 0.2% of smaller.

The haze value of the thin portion 13 can be adjusted by, for example, etching conditions that are employed in forming the recess 7. The haze value can be measured according to the Japanese Industrial Standard JIS K7136: 2000.

As shown in FIG. 6, the bottom surface 8 of the recess 7 may have a shape projecting more in the Z direction (toward the outside of the recess 7) as the position goes toward its center. With this shape, the projected portion is increased in tactile feel. It is preferable that the thickness t₁ in the Z direction of a central portion (the portion projected most) of the projected portion of the bottom surface 8 is 5 μm or larger and 20 μm or smaller. If the thickness t₁ in the Z direction of the projected portion of the bottom surface 8 is larger than 20 the probability of erroneous recognition by the sensor becomes high. If thickness t₁ is smaller than 5 μm, a variation in tactile feel cannot be felt. The presence or absence of a projected portion of the bottom surface 8 and the thickness of the projected portion in the Z direction can be adjusted by, for example, etching conditions that are employed in forming the recess 7. The thickness t₁ in the Z direction of the projected portion of the bottom surface 8 can be measured with, for example, a laser displacement sensor LT-9000 produced by Keyence Corporation.

The cover member 1 includes chemically strengthened glass. The chemically strengthened cover member 1 is high in mechanical strength because the surface of the thin portion 13, that is, the whole of the first major surface 3 and the second major surface 5 are formed with a compressive stress layer.

In the cover member 1, it is preferable that the surface compressive stress CS in the thick portion 17 is larger than the surface compressive stress CS in the thin portion 13. With this structure, the thick portion 17 is less likely to break when the cover member 1 receives impact due to dropping or the like.

One specific method for making the surface compressive stress CS in the thick portion 17 larger than the surface compressive stress CS in the thin portion 13 is to set the chemical strengthening time longer than usual. Another method is to chemically strengthen the thick portion 17 selectively.

The internal tensile stress CT in the thin portion 13 and the internal tensile stress CT in the thick portion 17 are set as appropriate according to a use of the cover member 1.

For example, where the internal tensile stress CT in the thin portion 13 is set larger than the internal tensile stress CT in the thick portion 17, the thin portion 13 breaks first and absorbs the impact to prevent breaking of the thick portion 17 when the cover member 1 receives an unexpectedly strong impact.

This structure is advantageous when it is desired to protect the thick portion 17 with priority over the thin portion 13. A specific example is a case that the cover member 1 is a cover glass of a smartphone. This is because a function assigned to the thin portion 13, such as a fingerprint authentication function, is a collateral function or a function that can be replaced by another authentication means such as use of a password whereas in the smartphone whether the display screen provided to the thick portion 17 can be recognized visually has a great influence on the way of performing its functions.

As for specific internal tensile stress CT values, it is preferable that the internal tensile stress CT in the thin portion 13 is 50 MPa or larger and the internal tensile stress CT in the thick portion 17 is 50 MPa or smaller.

One specific method for making the internal tensile stress CT in the thin portion 13 larger than the internal tensile stress CT in the thick portion 17 is to make the thin portion 13 thinner and set the chemical strengthening time longer than usual. Another method is to chemically strengthen the thin portion 13 selectively.

Conversely, where the internal tensile stress CT in the thick portion 17 is set larger than the internal tensile stress CT in the thin portion 13, when the cover member 1 receives unexpectedly strong impact, the thick portion 17 breaks first and absorbs the impact to prevent breaking of the thin portion 13.

This structure is advantageous when it is desired to protect the thin portion 13 with priority over the thick portion 17. A specific example is a case that the cover member 1 is a cover glass of a security device that enables entrance/exit management using fingerprint authentication. This is because the content displayed on the display screen provided to the thick portion 17 is simple and can be replaced by audio or the like, whereas in the entrance/exit management whether personal authentication can be performed using a sensor or the like provided to the thin portion 13 has a great influence on the way of performing its function.

As for specific values, it is preferable that the internal tensile stress CT in the thick portion 17 is 50 MPa or larger and the internal tensile stress CT in the thin portion 13 is 50 MPa or smaller.

One specific method for making the internal tensile stress CT in the thick portion 17 larger than the internal tensile stress CT in the thin portion 13 is to make the thick portion 17 as thin as possible and set the chemical strengthening time longer than usual. Another method is to chemically strengthen the thick portion 17 selectively. Besides, another method is to strengthen both of the thick portion 17 and the thin portion 13 in such a manner that the thick portion 17 is more strengthened selectively.

In general, the internal tensile stress CT in chemically strengthened glass is approximately given by a relational equation CT=(CS×DOL)/(t−2×DOL) by using the thickness t, the surface compressive stress CS in a compressive stress layer, and the depth of the compressive stress layer DOL. Thus, for the same surface compressive stress CS and the same depth of the compressive stress layer DOL, the internal tensile stress CT increases as the thickness decreases. When common chemical strengthening in which a glass is immersed in an alkali metal salt is performed on a glass having a portion that is different in thickness from the other portion as in the cover member 1, ion exchange occurs isotropically from the first major surface 3 and the second major surface 5. Thus, the same surface compressive stress CS and the same depth of the compressive stress layer DOL are obtained irrespective of a partial thickness difference. In this case, if chemical strengthening is performed under conditions which are employed for an ordinary flat cover member, CT in the thin portion 13 becomes so high that the probability of occurrence of self-destruction of the thin portion is increased. On the other hand, if chemical strengthening is performed on the whole of such a glass under conditions for obtaining a surface compressive stress CS and a depth of a compressive stress layer DOL of such levels as not to cause destruction of the thin portion 13, the chemical strengthening necessarily becomes weak and hence the strength of the thick portion 17 becomes lower than the strength of a flat cover member not having a thin portion 13. In conclusion, it is preferable to give the thin portion 13 a surface compressive stress CS and a depth of a compressive stress layer DOL of such levels as not to cause destruction of the thin portion 13 while giving the thick portion 17 a surface compressive stress CS and a depth of a compressive stress layer DOL equivalent to those to be given to an ordinary flat cover member. That is, it is preferable that the depth of the compressive stress layer formed in the thin portion 13 is smaller than the depth of the compressive stress layer formed in the thick portion 17.

In the cover member 1, it is preferable that the first major surface 3 and the second major surface 5 are polished to increase their flatness. In the case where a polishing is performed by using a suede pad and a polishing agent that is polishing slurry containing cerium oxide or colloidal silica, flaws (cracks) in the first major surface 3 and the second major surface 5 and a warp and recesses of the cover member 1 can be eliminated. This increases the strength of the cover member 1. Although the polishing may be performed either before or after the chemical strengthening of the cover member 1, it is preferable that the polishing is performed after the chemical strengthening for the following reasons. It is because a glass sheet subjected to a chemical strengthening utilizing ion exchange has defects in the first major surface 3 and the second major surface 5. And minute unevenness measuring about 1 μm at the maximum may remain. When force acts on a glass sheet, the glass sheet may break even if the force is weaker than a theoretical strength because stress concentrates on a portion where such defect or minute unevenness exists. For this reason, layers (defective layers) existing as topmost and bottommost layers of a glass sheet subjected to a chemical strengthening and having defects and minute unevenness are removed by the polishing. Usually, the thickness of the defective layers having defects is 0.01 to 0.5 μm though it depends on the chemical strengthening conditions.

Only the thick portion 17 may be subjected to polishing. This provides an effect that the sensitivity of sensing and visibility increase in the case where a sensor and a display panel are disposed on a second-major-surface-side surface 19. Furthermore, since the thick portion 17 relates to the strength of the entire cover member 1, the strength of the cover member 1 can be increased by removing defects thereof by polishing. Where the thick portion 17 of the cover member 1 subjected to a chemical strengthening is polished, the depth of the compressive stress layer DOL of the recess 7 becomes larger than that of the thick portion 17. That is, a cover member 1 can be obtained in which the strength of the thin portion 13 is maintained.

Polishing may be performed on the bottom surface 8 and the side surface 9 of the recess 7. This provides an effect that the sensitivity of sensing and visibility increase in the case where a sensor and a display panel are disposed in the recess 7. Where the recess 7 of the cover member 1 subjected to a chemical strengthening is polished, the depth of the compressive stress layer DOL of the thick portion 17 becomes larger than that of the recess 7. Removing a dissimilar layer that was formed during formation of the recess 7 by polishing makes it easier to form an antifouling layer which will be described later.

Where the cover member 1 is used for protecting a display device such as a personal data assistance or a display panel, the thickness of the thick portion 17 in the Z direction is preferably 5 mm or smaller, even preferably 2 mm or smaller, further preferably 1.5 mm or smaller, and particularly preferably 0.8 mm or smaller. There are no problems of workability if the thickness of the thick portion in the Z direction is 5 mm or smaller. The thickness of the thick portion 17 in the Z direction is 0.1 mm or larger, preferably 0.15 mm or larger, and even preferably 0.2 mm or larger, in order to increase rigidity thereof.

The maximum thickness of the thin portion 13 in the Z direction is preferably 1 mm or smaller, even preferably 0.4 mm or smaller, further preferably 0.35 mm or smaller, even further preferably 0.3 mm or smaller, particularly preferably 0.25 mm or smaller, especially preferably 0.2 mm or smaller, and most preferably 0.1 mm or smaller. In particular, where a capacitive sensor is disposed on the back side of the recess 7 of the thin portion 13, the detected capacitance increases to make the sensitivity of sensing higher as the thin portion 13 is made thinner. For example, also in the case of fingerprint authentication in which minute unevenness of a fingerprint of a fingertip is detected, differences between capacitance values corresponding to minute unevenness of a fingerprint of a fingertip increase to enable detection with higher sensitivity of sensing. On the other hand, although there are no particular limitations on the lower limit of the thickness of the thin portion 13 in the Z direction, for the thin portion 13 which is very thin, the thickness of the thin portion 13 in the Z direction is preferably 0.01 mm or larger, even preferably 0.05 mm or larger, in order to secure strength necessary as a protection portion for a sensor or the like.

The thickness of the thin portion 13 in the Z direction is preferably smaller than or equal to ½, even preferably smaller than or equal to ⅓, and further preferably smaller than or equal to ¼, of the thickness of the thick portion 17 in the Z direction. On the other hand, since the thin portion 13 being thick to some extent can suppress buckling, it is preferable that the thickness of the thin portion is larger than or equal to ⅕ of the thickness of the thick portion 17. The term “buckling” means a phenomenon that when the load on a material is increased, the manner of its deformation changes suddenly and the material is warped to a large extent.

There are no particular limitations on the lower limit of the area ratio of the thickness in the Z direction of the thick portion 17 and it can be set according to the use. In a use of protection of a personal data assistance, the area ratio is typically 1.5 or larger. The ratio of the area of the thin portion 13 with respect to the area of the thick portion 17 is ½ or smaller, preferably ⅓ or smaller, and even preferably ¼ or smaller. If the ratio of the area of the thin portion 13 with respect to the area of the thick portion 17 is larger than ½, there is a concern that the strength may be made extremely low. The thickness of the thin portion 13 in the Z direction can be measured with, for example, a laser displacement sensor LT-9000 produced by Keyence Corporation.

Young's modulus of the thin portion 13 is preferably 60 GPa or larger, even preferably 65 GPa or larger, and further preferably 70 GPa or larger. If Young's modulus of the thin portion 13 is 60 GPa or larger, the thin portion 13 can be prevented sufficiently from being damaged due to collision with an object coming from the outside. Where a fingerprint authentication sensor is disposed in the recess 7, the thin portion 13 can be prevented sufficiently from being damaged due to a drop or collision of a smartphone or the like. Furthermore, a sensor that is protected by the thin portion 13 can be prevented sufficiently from being, for example, damaged. Although there are no particular limitations on the upper limit of Young's modulus of the thin portion 13, from the viewpoint of productivity, Young's modulus of the thin portion 13 is preferably 200 GPa or smaller, even preferably 150 GPa or smaller.

The Vickers hardness Hv of the thin portion 13 is preferably 400 or larger, even preferably 500 or larger. If the Vickers hardness of the thin portion 13 is 400 or larger, the thin portion 13 can be prevented sufficiently from being scratched due to collision with an object coming from the outside. Where a fingerprint authentication sensor is disposed in the recess 7, the thin portion 13 can be prevented sufficiently from being scratched due to a drop or collision of a smartphone or the like. Furthermore, a sensor that is protected by the thin portion 13 can be prevented sufficiently from being, for example, damaged. Although there are no particular limitations on the upper limit of the Vickers hardness of the thin portion 13, from the viewpoint of the ease of polishing and working, the Vickers hardness is preferably 1,200 or smaller, even preferably 1,000 or smaller. The Vickers hardness can be measured by, for example, the Vickers hardness test that is described in the Japanese Industrial Standard JIS Z 2244: 2009.

The relative permittivity of the thin portion 13 at a frequency 1 MHz is preferably 7 or larger, even preferably 7.2 or larger, and further preferably 7.5 or larger. Where a capacitive sensor is disposed on the recess-side surface 15A of the thin portion 13, a large capacitance can be detected and hence high sensitivity of sensing can be realized by making the relative permittivity of the thin portion 13 large. In particular, if the relative permittivity of the thin portion 13 at the frequency 1 MHz is 7 or larger, also in the case of fingerprint authentication in which minute unevenness of a fingerprint of a fingertip is detected, differences between capacitance values corresponding to minute unevenness of a fingerprint of a fingertip become large and hence detection can be made with high sensitivity of sensing. There are no particular limitations on the upper limit of the relative permittivity of the thin portion 13. However, if the relative permittivity of the thin portion is too large, the dielectric loss and the power consumption may become large and the reaction may become slow. Thus, the relative permittivity of the thin portion 13 at the frequency 1 MHz is, for example, preferably 20 or smaller, even preferably 15 or smaller. The relative permittivity can be obtained by measuring a capacitance of a capacitor prepared by forming electrodes on the two respective surfaces of the cover member 1.

It is preferable that a printed layer is formed on the second major surface 5 of the cover member 1. In particular, as shown in FIG. 2, where the back surface (second major surface 5) of the cover member 1 is formed with the recess 7, it is preferable that a printed layer is also formed on the recess 7 (recess-side surface 15A). Forming such printed layers makes it possible to effectively prevent the inside of a personal data assistance as a protection target of the cover member 1 and a fingerprint authentication sensor disposed on the recess-side surface 15 of the thin portion 13 from being recognized visually through the cover member 1, and also makes it possible to give the cover member 1 a desired color to thereby allow it to have superior appearance. To keep the capacitance of the cover member 1 (thin portion 13) large, the thinner the printed layer is, the better it is. The thickness of the printed layer is preferably 30 μm or smaller, even preferably 25 μm or smaller, and particularly preferably 10 μm or smaller. However, in the case of white printing using ink containing a compound having large relative permittivity (e.g., ink containing TiO₂), since the relative permittivity of the printed layer is large, the thickness of the printed layer is preferably 100 μm or smaller, even preferably 50 μm or smaller, and particularly preferably 25 μm or smaller.

Where a printed layer is formed on the second major surface 5 of the cover member 1, a sensor is disposed at a position (on the back side of the thin portion 13) opposed to the recess 7 in the Z direction on the back surface of the printed layer. Thus, the arithmetic mean roughness Ra of a topmost surface of the printed layer is preferably 50 nm or smaller, even preferably 45 nm or smaller, and further preferably 30 nm or smaller. Furthermore, the arithmetic mean roughness Ra of the back surface is preferably 50 nm or smaller, even preferably 45 nm or smaller, and further preferably 30 nm or smaller. The arithmetic mean roughness Ra of each of the topmost surface and the back surface of the printed layer being 50 nm or smaller is preferable because their unevenness is at levels of sufficiently smaller than unevenness of a fingerprint and hence the sensitivity of sensing is made high. Although there are no particular limitations on the lower limit of the arithmetic mean roughness Ra of each of the topmost surface and the back surface of the printed layer, it is preferably 2 nm or larger, even preferably 4 nm or larger.

When the above-described cover member 1 is incorporated in a body or the like to protect any surface(s) required to be protected (e.g., front surface or side surfaces) of a personal data assistance or a display device, a sensor for, for example, fingerprint authentication or a display panel such as a liquid crystal panel or an organic EL panel can be disposed on the recess-side surface 15A of the thin portion 13. Since the sensor attached to the recess-side surface 15A of the thin portion 13 is protected by the thin portion 13 which is opposed to it in the Z direction, a cover member 1 can be realized that is uniform in material and high in sense of unity and is thus superior in design, without use of a sensor cover or the like made of a different material. Furthermore, this structure is very effective in cost reduction because the number of members used is small and the assembling process can be simplified. Still further, since the number of openings for incorporation of other members can be reduced, waterproofness and drip-proofness can be attained easily.

### (Manufacturing Method of Cover Member)

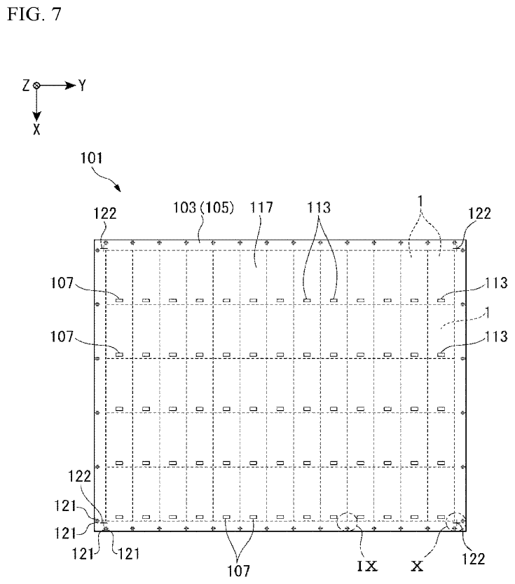

The above-described cover member 1 is obtained by cutting out a portion including at least one recess 107 from a glass substrate 101 having plural recesses 107 as shown in FIG. 7.

The structure of the glass substrate 101, a manufacturing method of the glass substrate 101, and a manufacturing method of the cover member 1 will be described in detail below in this order.

### (Glass Substrate)

FIG. 7 shows the glass substrate 101 from which the plural cover members 1 are to be cut out. In FIG. 7, outlines of the cover members 1 to be cut out are indicated by broken lines; the plural cover members 1 are obtained by cutting the glass substrate 101 along the broken lines. Although in this example the cutting lines are straight lines as indicated by the broken lines, they need not always be straight lines and may be curved lines.

One of a first major surface 103 (the surface on the viewer's side in FIG. 7) or a second major surface 105 of the glass substrate 101 is formed with plural recesses 107. FIG. 7 shows an example in which the first major surface 103 is formed with plural recesses 107. As described later, the plural recesses 107 are formed by, for example, etching treatment, grinding treatment, or heating deformation.

The glass substrate 101 has plural thin portions 113 that are formed by the formation of the plural recesses 107 and a thick portion 117 that is connected to the plural thin portions 113. The plural recesses 107 are arranged at a constant interval in each of the X direction and the Y direction. Thus, the thin portions 113 are also arranged at the constant interval in each of the X direction and the Y direction. The plural recesses 107 need not always be arranged at a constant interval; they may be arranged at plural kinds of intervals or a part of them may be arranged at random intervals. However, to increase the space efficiency in cutting out the plural cover members 1, it is preferable to arrange the plural recesses 107 at a constant interval and to lay the cover members 1 without gaps as shown in FIG. 7.

The structures (shape, dimensions, etc.) of each recess 107 and each thin portion 113 of the glass substrate 101 are the same as those of the recess 7 and the thin portion 13 of the above-described cover member 1. That is, the arithmetic mean roughness Ra of the surface, on the side of the first major surface 103, of each thin portion 113 is preferably 50 nm or smaller, even preferably 45 nm or smaller, and further preferably 30 nm or smaller. The haze value of each thin portion 113 is preferably 8% or smaller, even preferably 7% or smaller. As in the recess 7 of the cover member 1 (see FIG. 6), the bottom surface of each recess 107 of the glass substrate 101 may be shaped so as to project more as the position goes toward its center.

It is preferable that the side surface of each recess 107 of the glass substrate 101 has a curved surface shape connected smoothly to the bottom surface of the recess 107, like the side surface 9 of the recess 7 of the cover member 1 (see (A) of FIG. 2 to FIG. 6). It is preferable that the radius of curvature of the side surface of each recess 107 increases as the position goes from a central portion of the recess 107 to a circumferential portion. It is preferable that the radius of curvature of the side surface of each recess 107 is set longer than or equal to the depth of the bottom surface of the recess 107. It is preferable that the radius of curvature of the side surface of each recess 107 is 0.1 mm or longer and 2 mm or shorter. It is preferable that a portion where the side surface of each recess 107 is connected to the first major surface 103 or the second major surface 105 have a smooth, continuous curved surface shape like the portion of the cover member 1 where the side surface 9 of the recess 7 is connected to the first major surface 3 or the second major surface 5 (see FIG. 3 and FIG. 5).

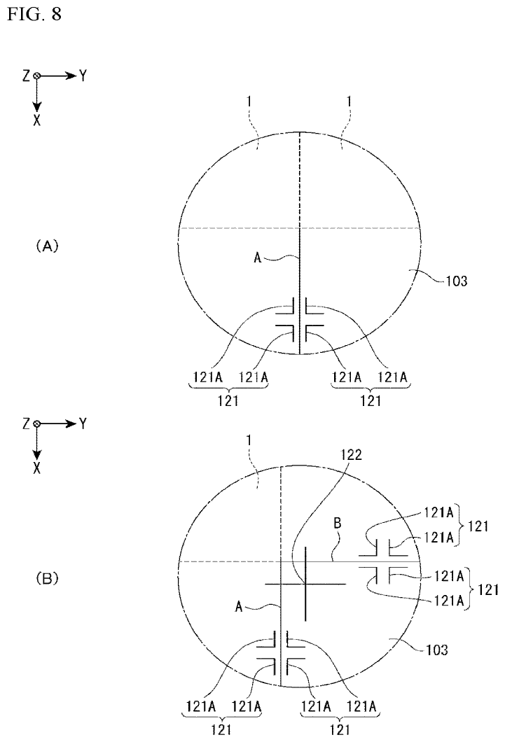

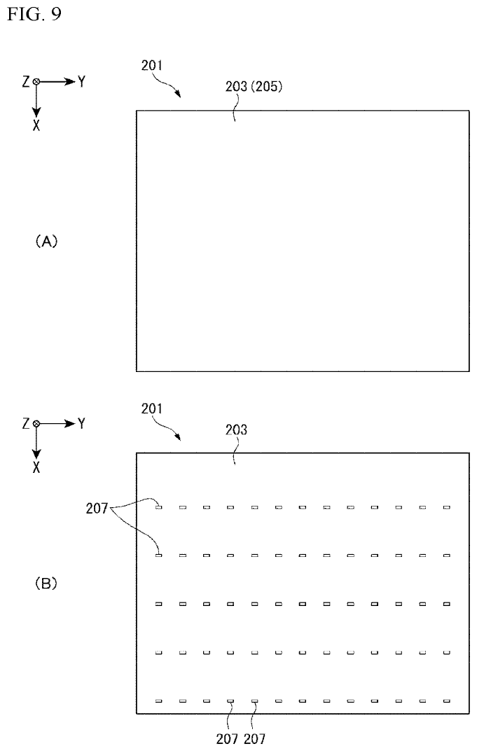

As shown in (A) of FIG. 8 and (B) of FIG. 8, at least one of the first major surface 103 and the second major surface 105 of the glass substrate 101 is provided with plural first marks 121 and plural second marks 122 for performing a positioning in cutting out the plural cover members 1. As shown in (A) of FIG. 8 and (B) of FIG. 8, extension lines in the X direction and the Y direction of the outlines (indicated by broken lines in FIG. 8 and FIG. 9) of the cover members 1 are denoted by symbols A and B, respectively. A pair of the first marks 121 is arranged on the two respective sides of the extension line A extending in the X direction in the vicinity of the cover member(s) 1 and arranged on the two respective sides of the extension line B extending in the Y direction in the vicinity of the cover member(s) 1. Each first mark 121 consists of a pair of first mark pieces 121A. Each first mark piece 121A is approximately shaped like L that consists of two orthogonal lines. Lines which are adjacent to each other of first mark pieces 121A are opposed to each other with a slight gap. The second marks 122 are formed at the four respective corners of the glass substrate 101. Each second mark 122 is approximately shaped like a cross consisting of two orthogonal lines. Of the two lines that constitute each second mark 122, a part of the line that is parallel with the extension line A extending in the X direction crosses the extension line B extending in the Y direction and a part of the line that is parallel with the extension line B extending in the Y direction crosses the extension line A extending in the X direction.

In cutting out the cover member 1 from the glass substrate 101, it is possible to check whether cutting is being performed correctly by selecting a cutting position by reading the positions of the second marks 122 and checking whether a cutting line passes through the middle line of the first mark 121 (i.e., an extension line A extending in the X direction or an extension line B extending in the Y direction).

### (Manufacturing Method of Glass Substrate)

Next, a manufacturing method of the glass substrate 101 will be described. First, raw materials of respective components are mixed so as to prepare a composition described later and a resulting mixture is heated and melted in a glass furnace. The glass is homogenized by, for example, bubbling, stirring, or addition of a refining agent, shaped into a glass sheet having a prescribed thickness by a known shaping method, and annealed. Examples of glass shaping methods include a float process, a press process, a fusion process, a down-draw process, and a roll-out process. The float process suitable for mass-production is particularly preferable. The continuous shaping method other than the float process, that is, the fusion process and the down-draw process are also preferable. A glass member that has been shaped into a flat sheet shape by an optional method is annealed and cut into a desired size (i.e., a size of a glass member 201). Where, for example, more correct dimensional accuracy is required, the cut-out glass member may be subjected to polishing. As a result, a glass member 201 which has a flat first major surface 203 and a flat second major surface 205 and is shaped like a flat sheet as a whole as shown in (A) of FIG. 9 is obtained.

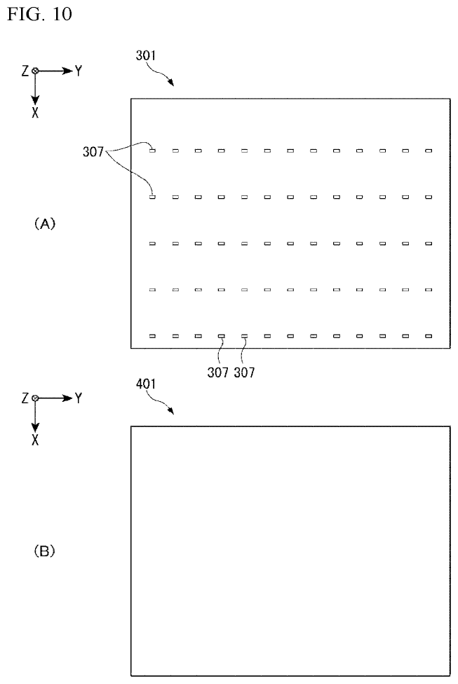

Then a stage proceeds to a recess forming process for forming recesses 207 in one of the first major surface 203 and the second major surface 205 of the glass member 201. In an example described below, as shown in (B) of FIG. 9, recesses 207 are formed in the first major surface 203 of the glass member 201. In the recess forming process, the glass member 201 is subjected to an etching treatment in a state that a first mask member 301 shown in (A) of FIG. 10 and a second mask member 401 shown in (B) of FIG. 10 are put on the first major surface 203 and the second major surface 205, respectively.

An X-direction dimension and a Y-direction dimension of the first mask member 301 are set so that the entire first major surface 203 of the glass member 201 can be covered with the first mask member. In the example shown in (A) of FIG. 10, the X-direction dimension and the Y-direction dimension of the first mask member 301 are approximately equal to the X-direction dimension and the Y-direction dimension of the glass member 201, respectively. Furthermore, plural recess-forming holes 307 for forming plural recesses 207 to the glass member 201 are formed in the first mask member 301 at a prescribed interval in each of the X direction and the Y direction. Thus, etchant reaches the first major surface 203 of the glass member 201 through the plural recess-forming holes 307, whereby plural recesses 207 are formed.

An X-direction dimension and a Y-direction dimension of the second mask member 401 are set so that the entire second major surface 205 of the glass member 201 can be covered with the second mask member. In the example shown in (B) of FIG. 10, the X-direction dimension and the Y-direction dimension of the second mask member 401 are approximately equal to the X-direction dimension and the Y-direction dimension of the glass member 201, respectively. The entire second major surface 205 of the glass member 201 is covered with the second mask member 401 to prevent the back surface from being etched.

The first mask member 301 and the second mask member 401 includes an etchant-resistant material such as a resist such as a photosensitive organic material or particularly a photosensitive resin material, a resin, a metal film, or a ceramic. The recess-forming holes 307 are formed by performing exposure to light and development in prescribed manners in the case where the material is a resist.

Although the etching treatment may be either wet etching or dry etching, wet etching is preferable from the viewpoint of cost. Examples of etchants include solutions mainly including hydrofluoric acid in the case of wet etching, and a fluorine-based gas in the case of dry etching. An etching treatment makes it possible to obtain a glass substrate having plural recesses 207 in a simple manner.

It is preferable that etching is performed while the glass member 201 and the etchant are moved relative to each other in directions (X and Y directions) that are parallel with the first major surface 203 or the second major surface 205 of the glass member 201. Such etching may be performed while the glass member 201 is swung in the X and Y directions and/or the etchant is caused to flow in the X and Y directions. Basically, etching proceeds isotropically with respect to the glass member 201. Thus, in a portion directly under the sides of the opening of each recess-forming hole 307 of the first mask member 301, etching proceeds sideways with a radius that is approximately equal to an etching depth. As a result, the side surface of each recess 207 of the glass member 201 is given a curved surface shape that is connected to the bottom surface of the recess 207 smoothly as in each recess 7 of the cover member 1 (see (A) of FIG. 2 to FIG. 6). Where etching is performed while the glass member 201 and the etchant are moved relative to each other in the X and Y directions, a turning flow occurs from the sides of the opening of each recess-forming hole 307 of the first mask member 301 toward the recess 207 of the glass member 201 and hence the speed of a flow from a peripheral portion of the recess 207 toward the side surface is higher than the speed of a flow around a central portion of the recess 207. As a result, the rate of etching from the circumference of each recess 207 toward the side surface is made higher relatively, whereby the radius of curvature of the side surface of each recess 207 can be made to increase as the position goes from a central portion of the recess 207 to its circumferential portion. The radius of curvature of the side surface of each recess 207 can be made larger than or equal to the depth of the bottom surface of the recess 207. The radius of curvature of the side surface of each recess 207 can be made larger than or equal to 0.1 mm and smaller than or equal to 2 mm by adjusting the etching processing time and the relative movement speed between the glass member 201 and the etchant. Furthermore, where etching is performed while the glass member 201 and the etchant are moved relative to each other in directions (X and Y directions) that are parallel with the first major surface 203 or the second major direction 205 of the glass member 201, the bottom surface of each recess 207 can be shaped so as to project more as the position goes toward its center.

To make the arithmetic mean roughness Ra of the bottom surface of each recess 207 smaller than or equal to 50 nm, etching treatment may be performed such that the flowability of etchant adjacent to the surface of the glass member 201 is increased. To make the above-described haze value smaller than or equal to 8%, etching treatment may be performed such that the flowability of etchant adjacent to the surface of the glass member 201 is increased. To shape the bottom surface of each recess 207 such that it projects more as the position goes toward the center, etching treatment may be performed so as to form a flow that collides with corner portions of the recess 207.

The method for forming the recesses 207 in one of the first major surface 203 and the second major direction 205 of the glass member 201 is not limited to the above-described etching method and may be a mechanical working method. In the mechanical working method, a machining center or some other numerical control machine tool is used so that recesses 207 having prescribed dimensions are ground and a polished surface is obtained by rotating and displacing a grindstone being in contact with the first major surface 203 or the second major direction 205 of the glass member 201. For example, grinding is performed using a grindstone to which diamond abrasives, CBN abrasives, or the like are fixed by electrodeposition or metal bonding under a setting of the spindle rotation speed and the machining speed at 100 to 30,000 rpm and 1 to 10,000 mm/min, respectively.

In the above-described manner, the radius of curvature of the side surface of each recess 207 can be made to decrease as the position goes from a central portion of each recess 207 to its circumferential portion. The radius of curvature of the side surface of each recess 207 can be made smaller than the depth of bottom surface of each recess 207. By virtue of these measures, no unnecessary gap is formed when a sensor or a display panel is disposed in the recess 7 after a cover member 1 has been cut out and a device that is superior in appearance can be obtained. Like a connection portion between the side surface 9 of the recess 7 of the cover member 1 and the first major surface 3 or the second major surface 5 (see FIG. 3 and FIG. 5), it is preferable that a connection portion between the side surface of each recess 207 and the first major surface 203 or the second major direction 205 has a smooth, continuous curved surface shape. Such a curved surface shape can be obtained by, for example, polishing the connection portion.

The bottom surface and the side surface of each recess 207 may be polished thereafter. In this polishing step, a polish-working portion of a rotary polishing tool is brought into contact with the bottom surface and the side surface of each recess 207 individually at independent constant pressures and moved relative to the bottom surface and the side surface at a constant speed. A polishing target surface can be polished uniformly at a constant polishing rate by polishing it at a constant pressure and a constant speed. From the viewpoints of economy, the ease of control, etc., it is preferable that the pressure of the polish-working portion of the rotary polishing tool is in a range of 1 to 1,000,000 Pa. From the viewpoints of economy, the ease of control, etc., it is preferable that the speed is in a range of 1 to 10,000 mm/min. A movement distance is determined as appropriate according to the shape and the size of the glass member 201. Although there are no particular limitations on the type of the rotary polishing tool as long as its polish-working portion is a rotary body capable of polishing, a type in which a polishing tool is attached to a spindle having a tool chucking portion or a leutor is exemplified. There are no particular limitations on the material type of the rotary polishing tool as long as at least its polish-working portion is made of a cerium pad, rubber grindstone, felt buff, polyurethane, or the like capable of working and removing a working target and has Young's modulus that is preferably 7 GPa or smaller, even preferably 5 GPa or smaller. Where a member made of a material having Young' modulus of 7 GPa or smaller is used as a rotary polishing tool, the bottom surface and the side surface can be worked so as to have surface roughness in the above-described range by deforming the polish-working portion by pressure so that it conforms to the shape of each recess 207. Examples of shapes of the polish-working portion of the rotary polishing tool include a circular or doughnut-flat shape, a cylinder shape, a bullet shape, a disc shape, and a barrel shape.

When the bottom surface and the side surface of each recess 207 is polished by bringing the polish-working portion of the rotary polishing tool into contact with them, it is preferable that the polishing is performed with intervention of abrasive slurry. Examples of abrasives to be used for this purpose include silica, ceria, Alundum (registered trademark), White Alundum (WA, registered trademark), emery, zirconia, SiC, diamond, titania, and germania, and it is preferable that their grain size is in a range of 10 nm to 10 μm. As mentioned above, the relative movement speed of the rotary polishing tool can be selected from the range of 1 to 10,000 mm/min. The rotation speed of the polish-working portion of the rotary polishing tool is in a range of 100 to 10,000 rpm. If the rotation speed is low, the processing rate becomes slow and thus it may take too long a time to obtain desired surface roughness. If the rotation speed is high, the processing rate becomes too high or the tool wears too fast, and thus a polishing control may become difficult.

When as described above, the bottom surface and the side surface of each recess 207 is polished by bringing the rotary polishing tool into contact with them at independent pressures, the pressure control can be performed using a pneumatic piston, a load cell, or the like. For example, the pressure at which the polish-working portion is brought into contact with the bottom surface and the side surface of each recess 207 can be adjusted by providing a pneumatic piston for advancing and retracting the rotary polishing tool toward and from the bottom surface of the recess 207 and another pneumatic piston for advancing and retracting the rotary polishing tool toward and from the side surface of the recess 207. In this manner, the bottom surface and the side surface of each recess 207 can be polished uniformly at the same time at independent polishing rates by making pressures to the bottom surface and the side surface of each recess 207 independent each other and moving the single rotary polishing tool relative to the bottom surface and the side surface at a constant speed while bringing the rotary polishing tool into contact with those surfaces at independent, constant pressures.

Alternatively, polishing may be performed by moving the rotary polishing tool and the glass member 201 relative to each other so that the rotary polishing tool is moved along the shape of each recess 207. There are no particular limitations on the moving method as long as the movement distance, direction, and speed can be controlled so as to be kept constant. An example of this method is a method using a multi-axis robot.

First marks 121 and second marks 122 are formed by a method such as laser marking or printing on the glass member 201 that is formed with the plural recesses 207 in the above-described manner (see (B) of FIG. 9), whereby a glass substrate 101 as shown in FIG. 7 is obtained. Then plural cover members 1 are cut out by determining cutting positions by reading the positions of the second marks 122 and cutting the glass substrate 101 by a cutting tool such as a diamond cutter. It is confirmed that the cover members 1 have been cut out with a desired shape by checking whether each cutting line passes through the middle line (an extension line A extending in the X direction or an extension line B extending in the Y direction) of a pair of first marks 121.

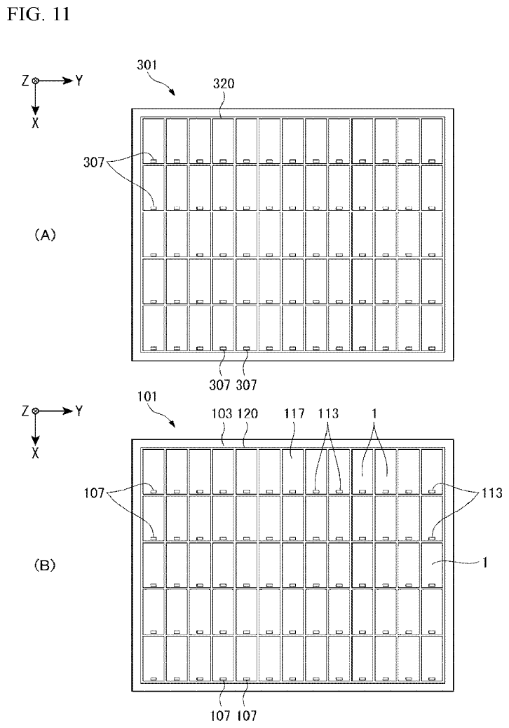

As shown in (A) of FIG. 11, the first mask member 301 may have a groove forming hole 320 that corresponds to outlines of plural cover members 1. When etching is performed using such a first mask member 301, as shown in (B) of FIG. 11, a groove 120 corresponding to outlines of the plural cover members 1 is formed in the first major surface 103 of the glass substrate 101. The plural cover members 1 can be cut out by cutting the glass substrate 101 along the groove 120. By forming the groove 120 corresponding to outlines of the cover members 1 in the glass substrate 101 in advance, the cover members 1 can be cut out more correctly. Furthermore it is not necessary to prepare a mask having outline shapes of cover members which has been used in a conventional technique.

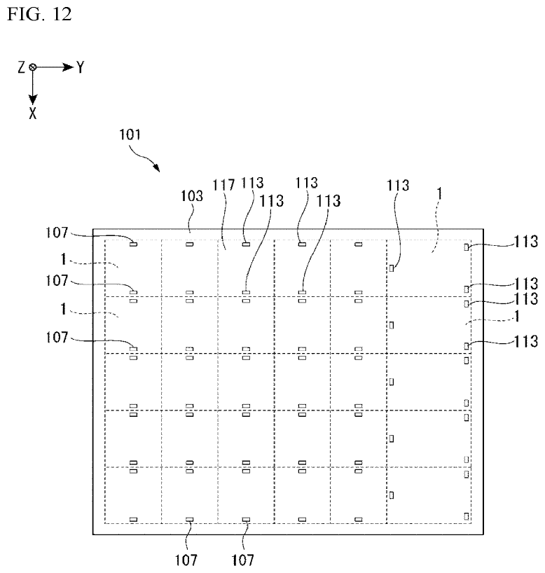

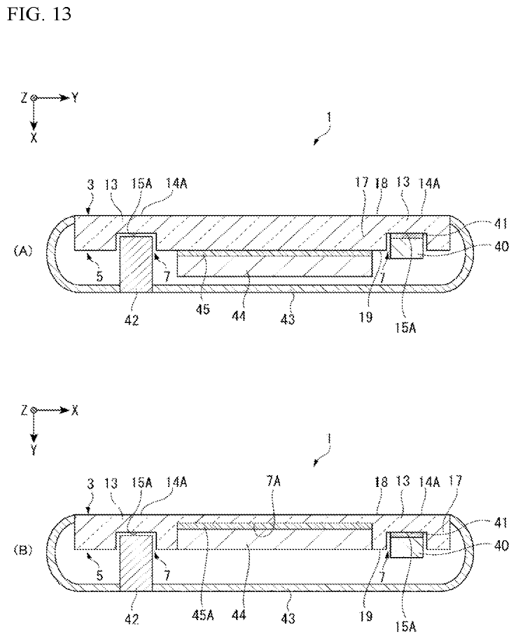

As shown in FIG. 12, plural cover members 1 may be cut out from the glass substrate 101 in such a manner that each cover member includes plural recesses 107. For example, as shown in (A) of FIG. 13, in the case where the number of various devices such as a sensor 40 and a camera module 42 which should be arranged on the back side of each cover member 1 is plural, recesses 107 are formed in the same number as the number of devices such as the sensor 40 and the camera module 42.

(A) of FIG. 13 shows a state that the sensor 40, the camera module 42, and a liquid crystal panel 44 (display panel) are housed in a body 43 of a smartphone or the like. The liquid crystal panel 44 is fixed to the second major surface 5 (the second-major-surface-side surface 19 of the thick portion 17) of the cover member 1 via an adhesive layer 45. A lens-side end portion of the camera module 42 is fixed to the body 43. In this type of structure, there may occur a case that another end side portion of the camera module 42 sticks out of the body 43. However, as shown in this figure, a part of the thickness of the camera module 42 can be absorbed by forming a recess 7 in the second major surface 5 of the cover member 1 at the position where the cover member 1 is opposed to the camera module 42 and thereby housing a base portion of the camera module 42 in the recess 7. This contributes to providing a flush surface including a camera portion to a device for which a reduction in thickness is advancing. An alternative structure is possible in which the camera module 42 is set in such a manner that its end portion and base portion are located at positions opposite to the positions shown in this figure and the lens of the camera module 42 is fixed to the recess 7 of the cover member 1. In this structure, the recess 7 of the cover member 1 functions like a “lens protector” that is commonly used for the lens of a single-lens reflex camera and provides advantages that it protects the camera lens and prevents entrance of dust. In this case, the bottom surface of the recess 7 (recess-side surface 15A) needs to be subjected to optical polishing and the side surface of the recess 7 needs to be shielded from light. An antifouling layer for making a fingerprint less likely to be left, an antireflection layer such as MgF₂, or a like may be formed in the recess 7 or the flat-portion-side surface 14A of the thin portion 13.

(B) of FIG. 13 shows a state that a recess 7A is formed in the cover member 1 shown in (A) of FIG. 13 and a liquid crystal panel 44 is disposed in the recess 7A via an adhesive layer 45A. In this structure, since the liquid crystal panel 44 is disposed in the recess 7A of the cover member 1, advantages are obtained that the liquid crystal panel 44 is protected and entrance of dust is prevented.

There are no particular limitations on the shape of each recess 107 and each the recess may have any shape. For example, the sectional shape of each recess 107 as viewed from the Z direction is not limited to a rectangle and may be a circle, an elongated circle, an ellipse, a triangle, or the like.

### (Manufacturing Method of Cover Member)

Next, a manufacturing method of the cover member 1 will be described. As described above, each kind of the cover members 1 shown in FIG. 1 to FIG. 6 is obtained by cutting out plural cover members 1 from the glass substrate 101 in such a manner that each cover member 1 includes at least one recess 107.

Plural cover members 1 may be cut out after chemically strengthening the glass substrate 101. Alternatively, each cover member 1 may be chemically strengthened after plural cover members 1 are cut out. In the former case, a polishing process and a chemical strengthening process can be performed on a large-size sheet and hence can be increased in efficiency. In the latter case, processes can be performed even when facilities such as a polishing machine and an ion exchange bath are small, and the end surfaces of each cover member 1 can be strengthened, whereby the strengths of end faces tend to be improved.

The chemical strengthening means replacement (ion exchange) of alkali ions having a small ion radius (e.g., sodium ions) in a surface layer of glass with alkali ions having a large ion radius (e.g., potassium ions). There are no particular limitations on the method of the chemical strengthening as long as alkali ions in a surface layer of glass can be replaced with alkali ions having a larger ion radius by ion exchange. An example method is to process glass containing sodium ions with a molten salt containing potassium ions. After performing an ion exchange process, the composition of a central portion of a substrate in its thickness direction remains approximately the same as the composition thereof before performing the ion exchange process though the composition of a compressive stress layer in the glass surface layer is somewhat different from the composition thereof before performing the ion exchange process.

Where glass to be subjected to a chemical strengthening is glass containing sodium ions, it is preferable that the molten salt to be used for the chemical strengthening is a molten salt that contains at least potassium ions. A preferable example of such a molten salt is potassium nitrate. It is preferable to use a molten salt that is high in purity. The chemical strengthening is performed one or more times and may be performed two or more times under different sets of conditions.

The molten salt may be a mixed molten salt containing another or other components. Examples of the other components include alkali sulfate salts such as sodium sulfate and potassium sulfate, alkali chloride salts such as sodium chloride and potassium chloride, carbonate salts such as sodium carbonate and potassium carbonate, and bicarbonate salts such as sodium bicarbonate and potassium bicarbonate.

The heating temperature of the molten salt is preferably 350° C. or higher, even preferably 380° C. or higher, and further preferably 400° C. or higher. And the heating temperature of the molten salt is preferably 500° C. or lower, even preferably 480° C. or lower, and further preferably 450° C. or lower. When the heating temperature of the molten salt is set higher than or equal to 350° C., a phenomenon that chemical strengthening become difficult to be performed due to reduction in ion exchange rate can be prevented. When the heating temperature of the molten salt is set lower than or equal to 500° C., decomposition or degradation of the molten salt can be suppressed.

To give glass a sufficient compressive stress, the time for bringing the glass into contact with the molten salt is preferably 1 hour or longer, even preferably 2 hours or longer. Since too long time of ion exchange lowers the productivity and lowers the compressive stress value due to relaxation, the time for bringing the glass into contact with the molten salt is preferably 24 hours or shorter, even preferably 20 hours or shorter. For example, glass is immersed in a potassium nitrate molten salt that is kept at 400° C. to 450° C. for 2 to 24 hours.

A compressive stress layer is formed in the surface layer of a chemically strengthened cover member 1. The surface compressive stress CS in the compressive stress layer is preferably 300 MPa or larger, even preferably 400 MPa or larger. When the surface compressive stress CS is 300 MPa or larger, both of the thin portion 13 and the thick portion 17 are less prone to break even if the cover member receives impact due to a drop or the like. The surface compressive stress CS can be measured with a surface stress meter (e.g., FSM-6000 produced by Orihara Industrial Co., Ltd.), for example.

Where sodium ions in a glass surface layer are ion-exchanged with potassium ions in a molten salt by a chemical strengthening, a depth of a compressive stress layer DOL formed by the chemical strengthening can be measured by any method. For example, an ion diffusion depth obtained by a measurement of an alkali ion concentration analysis (in this case, potassium ion concentration analysis) in the depth direction of glass that is performed using an EPMA (Electron Probe Micro Analyzer) can be regarded as a depth of a compressive stress layer DOL. That is, when the glass substrate 101 or the cover member 1 is subjected to a chemical strengthening, the potassium ion concentration is made higher in its major surface than in a central portion of the thick portion in a cross section taken along the thickness direction. The depth of a compressive stress layer DOL can also be measured with a surface stress meter (e.g., FSM-6000 produced by Orihara Industrial Co., Ltd.), for example. When lithium ions in a glass surface layer are ion-exchanged with sodium ions in a molten salt, an ion diffusion depth obtained by a measurement of a sodium ion concentration analysis in the depth direction of glass that is performed using an EPMA is regarded as a depth of a compressive stress layer DOL.

It is preferable that the strain point of the glass substrate 101 or the cover member 1 before being subjected to a chemical strengthening is 530° C. or higher. This is because relaxation of surface compressive stress CS is made less prone to occur by setting the strain point of the glass substrate 101 or the cover member 1 before being subjected to a chemical strengthening to be higher than or equal to 530° C.

To lower the degree of warp that may occur when the thin portion 13 is subjected to a chemical strengthening, a film may be formed on at least one of the flat-portion-side surface 14A (recess-side surface 14B) of the thin portion 13 and the recess-side surface 15A (flat-portion-side surface 15B) of the thin portion 13. Although not shown in any drawings, examples of such a film include a first-major-surface-side film formed on the flat-portion-side surface 14A of the thin portion 13, a second-major-surface-side film formed on its recess-side surface 15A, and side surface films formed on X-direction side surfaces 9A and Y-direction side surfaces 9B of the recess 7 (see (B) of FIG. 2).

Each of these films suppresses the position on which the film is formed from being chemically strengthened. To exert the chemical strengthening suppressing effect, it is preferable that the film contains an oxide, a nitride, a carbide, a boride, a silicide, a metal, or the like. This is because the diffusion coefficients of sodium ions and potassium ions in the film containing such a substance is smaller than that in glass.

Examples of the above-mentioned oxide include a non-alkali oxide and a composite oxide containing an alkali element or alkaline earth element, and among them SiO₂ is preferable. When SiO₂ is contained as the main component, the diffusion of sodium ions and potassium ions in the film is suppressed to proper levels. Furthermore, since the transmittance of the film is high and the refractive index of the film is close to that of glass, a change in appearance by the coating can be minimized. Furthermore, a film containing SiO₂ as the main component is high in physical and chemical durability.

The thickness of the film is preferably 10 nm or larger, even preferably 15 nm or larger, and further preferably 20 nm or larger. When the film thickness is 10 nm or larger, by virtue of the ion exchange preventing effect, chemical strengthening of the portion on which the film is formed can be suppressed. The chemical strengthening suppressing effect is enhanced as the film is made thicker.

The thickness of the film is preferably 1,000 nm or smaller, even preferably 500 nm or smaller, and further preferably 200 nm or smaller. If the film thickness exceeds 1,000 nm, there are concerns that the warp of the thin portion 13 may be increased contrary to the intention and the difference in appearance between the portion with the film and the portion without the film may be increased.

The chemical strengthening method is not limited to immersion into a molten salt. A method of applying an inorganic salt in a powder or paste form containing alkali ions that can be ion-exchanged with alkali ions existing in a surface layer of glass and are larger in ion radius may be employed. Since only the portion where the inorganic salt has been applied can be chemically strengthened, this method is suitable when it is desired to chemically strengthen only the thin portion 13 or the thick portion 17 selectively.

An antiglare treatment layer may be formed on the first major surface 3 or the second major surface 5 of the cover member 1 by an antiglare treatment. Another functional layer such as an antireflection layer, an antifouling layer, or an anti-fogging layer may be formed. It is preferable that the functional layer is formed on the first major surface 3 of the cover member 1.

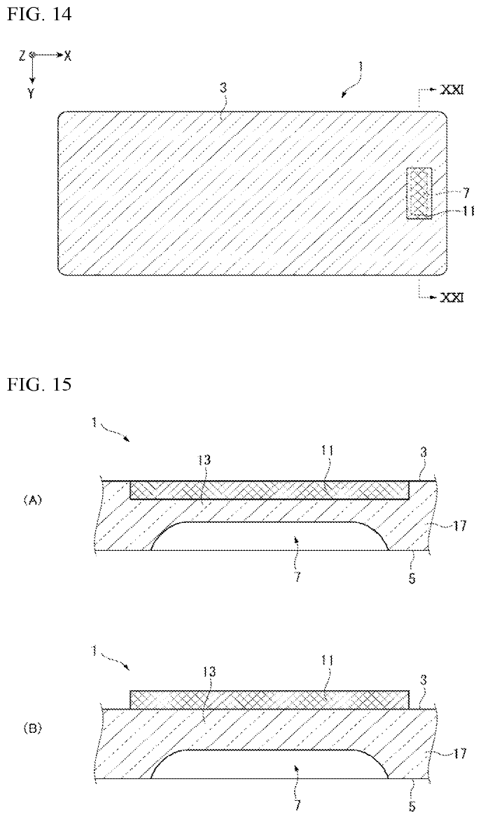

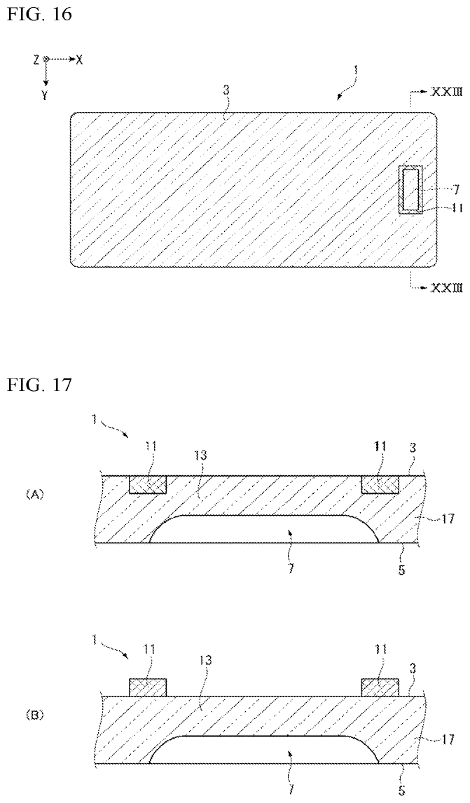

Examples of antiglare treatment include a treatment of etching with hydrofluoric acid or the like and a treatment of coating. In the case of an etching treatment, although the etching may be performed either before or after chemical strengthening, it is preferable that the etching is performed before chemical strengthening. In the case of a coating treatment, the coating may be performed either before or after chemical strengthening. In the case of an antiglare treatment layer formed by coating treatment, in a cross section taken along the thickness direction of the cover member 1, the composition of a central portion of the thick portion and the composition of the antiglare treatment layer can be made different from each other. As a result, the composition can be changed such that the refractive index of the antiglare treatment layer becomes smaller than the refractive index of the cover member 1, whereby an antireflection effect can be also obtained. Where the antiglare treatment layer is made of inorganic materials, it may be formed by either etching treatment or coating treatment. Where the antiglare treatment layer is made of organic materials, it may be formed by coating treatment. An inorganic fluoride or an inorganic chloride, for example, may be formed such that a layer including fluorine, chlorine, or the like is formed as a topmost layer of the cover member 1 or the antiglare treatment layer. Since this increases hydrophilicity, it becomes easier to remove stain by water cleaning.

Where the recess 7 is formed in the second major surface 5 of the cover member 1, it is conceivable to form an antiglare treatment region 11 on a portion, opposed to the recess 7, of the first major surface 3 as shown in FIG. 14, (A) of FIG. 15, and (B) of FIG. 15. Since the first major surface 3 of the cover member 1 is not formed with the recess 7 and hence is flat, a user cannot recognize a sensor position immediately when using an assembly. Performing antiglare treatment on the portion, opposed to the recess 7, of the first major surface 3 allows a user to recognize the sensor position by seeing an assembly. Certain antiglare treatment conditions provide an advantage that a user can recognize a sensor position immediately through tactility without seeing an assembly. Furthermore, as shown in FIG. 16, (A) of FIG. 17, and (B) of FIG. 17, it is preferable that an antiglare treatment region 11 is formed on at least a part of a circumferential portion of a portion, opposed to the recess 7, of the first major surface 3 of the cover member 1. A sensor as mentioned above is disposed in the recess 7 and detects, for example, the fingerprint of a finger that is in contact with a portion opposed to the recess 7. Forming the antiglare treatment region 11 in the circumferential portion of a portion opposed to the recess 7 makes it possible to maintain detection sensitivity.

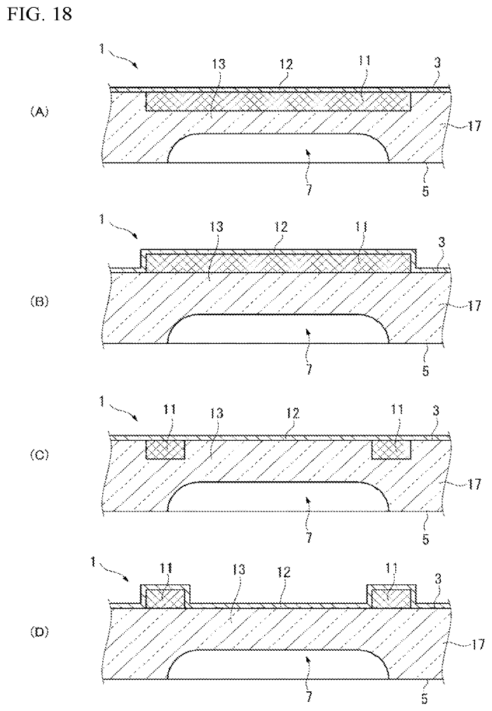

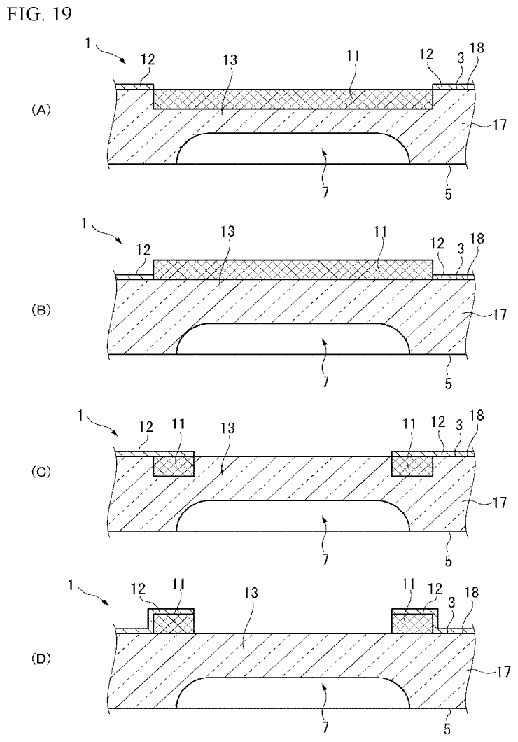

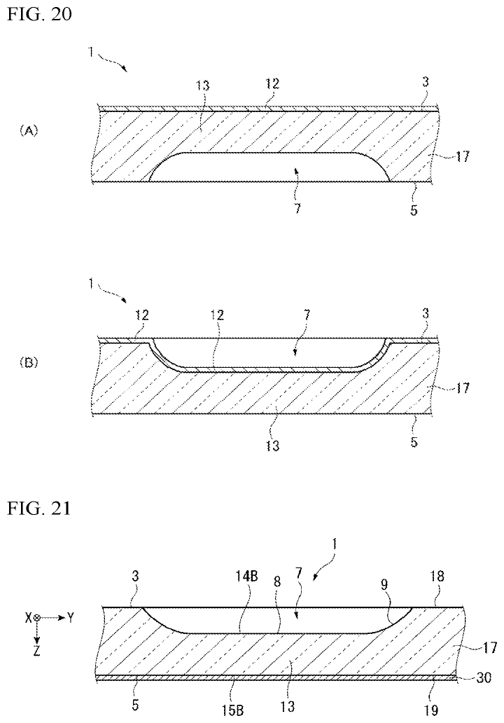

An antifouling layer (anti-fingerprint) 12 may be formed on the antiglare layer in manners shown in (A) to (D) of FIG. 18 and (A) to (D) of FIG. 19, for example. An antifouling layer 12 may be formed on the entire first major surface 3 of the cover member 1. With this measure, a fingerprint is less prone to be left even if a finger touches the cover member 1 and stain can easily be wiped out even if the cover member is stained. The antifouling layer 12 may be formed only on the flat-portion-side surface 14A of the thin portion 13 that is touched by a finger frequently when performing fingerprint authentication. Where the antifouling layer 12 includes a material that is prone to cause static electricity, the static electricity may lower the detection sensitivity of a sensor depending on the type of the sensor. In this case, as shown in (A) to (D) of FIG. 19, an antifouling layer 12 may be formed only on the first-major-surface-side surface 18 of the thick portion 17, not opposed to the recess 7, of the first major surface 3 of the cover member 1. As shown in (A) and (B) of FIG. 20, the antifouling layer 12 may be formed on the first major surface 3, not subjected to antifouling treatment, of the cover member 1.

The above-described functional layer(s) may be formed on the glass substrate 101 in advance.

It is preferable that the first major surface 3 and the second major surface 5 of the cover member 1 are polished. Minute projections and recesses or defects measuring about 1 μm at the maximum may be formed in the topmost surface and the bottommost surface of a strengthened glass sheet that was subjected to a chemical strengthening by ion exchange. When force acts on the cover member 1, the cover member 1 may break even if the force is weaker than a value corresponding to its theoretical strength because stress concentrates at portions of such minute projections and recesses or defects. In view of this, a layer having such defects or minute projections and recesses (a defect layer as part of the chemically strengthened layer) on each of the first major surface 3 and the second major surface 5 of a chemically strengthened cover member 1 is removed by polishing. The thickness of a defect layer having defects is usually in a range of 0.01 to 0.5 μm, though it depends on the chemical strengthening conditions. Polishing is performed by a double-sided polishing machine, for example. The double-sided polishing machine is configured so as to have a carrier attachment portion having a ring gear and a sun gear that are each driven rotationally at a prescribed rotation ratio and metal top and bottom surface plates that are disposed on the two respective sides of the carrier attachment portion and driven rotationally in opposite directions. Plural carriers which are in mesh with the ring gear and the sun gear are attached to the carrier attachment portion. The carriers make planetary gear motion in which they rotate on their centers and revolve around the sun gear serving as an axis. As such planetary gear motion is made, both surfaces (first major surface 3 and second major surface 5) of each of plural cover members 1 attached to the carriers are polished by friction against the top and bottom surface plates.

Furthermore, a printed layer may be formed on the second major surface 5 of the cover member 1. For example, the printed layer can be formed using an ink composition containing a prescribed colorant. The ink composition contains, in addition to the colorant, a binder, a dispersant, a solvent, etc. when necessary. The colorant may be any type of colorant (coloring agent) such as a pigment or a dye; either only a single kind of colorant or a combination of two or more kinds of colorants may be used. A proper colorant may be selected as appropriate according to a desired color; for example, a black colorant is used preferably when a shield function is required. Examples of the binder include known resins (thermoplastic resins, thermosetting resins, photosetting resins, etc.) such as a polyurethane resin, a phenol resin, an epoxy resin, a urea melamine resin, a silicone resin, a phenoxy resin, a methacrylic resin, an acrylic resin, a polyacrylate resin, a polyester resin, a polyolefin resin, a polystyrene resin, polyvinyl chloride, a vinyl chloride-vinyl acetate copolymer, polyvinyl acetate, polyvinylidene chloride, polycarbonate, cellulose, and polyacetal. Either only a single kind of binder or a combination of two or more kinds of binders may be used.

There are no particular limitations on the printing method for forming a printed layer; a printing method such as a photogravure printing method, flexography, an offset printing method, a letterpress printing method, a screen printing method, a pad printing method, a spray printing method, a film transfer method, and an inkjet method may be applied as required.

Where the recess 7 is formed in the first major surface 3 of the cover member 1 (see FIG. 4 to FIG. 5), it is easy to form a printed layer 30 on the second major surface 5 which is flat as shown in FIG. 21. It is made easier to recognize the position of the recess if the portion corresponding to the bottom surface 8 or the side surface 9 of the recess 7 is colored. If specular reflection printing (e.g., silver printing) is made to the portion corresponding to the side surface 9, a shape having the curvature of the side surface 9 exhibits a lens effect and reflection corresponding to the side surface 9 occurs in a wide angular range even if the angle of the cover member 1 is varied, whereby a high-grade feeling can be presented through glittering.

On the other hand, where the recess 7 is formed in the second major surface 5 of the cover member 1 (see FIG. 1 to FIG. 3), it is preferable that printing is performed individually in the recess 7 and on the flat portion, not formed with the recess 7, of the second major surface 5 of the cover member 1. This is because it is difficult to perform printing in the recess 7 and on the flat portion not formed with the recess 7 simultaneously because a printing method such as a screen printing method is not very high in shape followability. Thus, high-accuracy printing can be realized by performing printing on these portions individually. When the color or texture of printing is changed between recess 7 and the flat portion not formed with the recess 7, the position of a sensor 40 is made easy to be recognized visually and an accent in design can be provided.

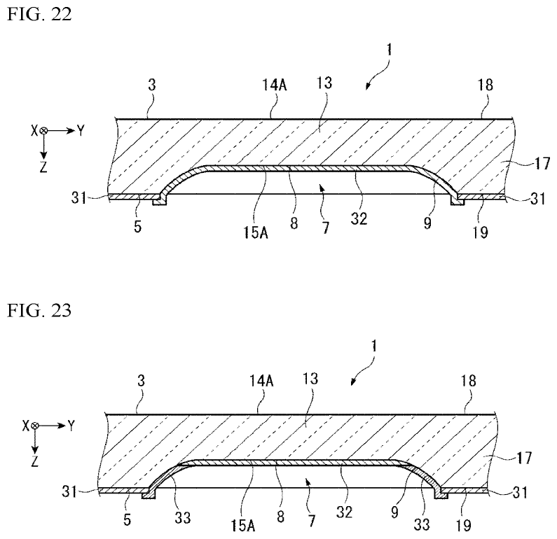

More specifically, as shown in FIG. 22, a first printed layer 31 is formed on the flat portion, not formed with the recess 7, of the second major surface 5 by the screen printing method or the like. The screen printing is a method in which a printing material is placed on a screen having openings and then a squeegee is slid on the screen while being pressed against it, whereby printing material is pushed out through the openings of the screen and a pattern of the openings is thereby printed. Since the recess 7 has the side surface 9 having a curved surface shape, use of a pad printing method is suitable for the recess 7. A second printed layer 32 is formed by this method on the bottom surface 8 and the side surface 9 of the recess 7. The pad printing method is a printing method in which a soft pad (e.g., silicone pad) whose surface is formed with an ink pattern is pressed against a target base member, whereby the ink pattern is transferred to the base member surface. The pad printing is also called tako (octopus) printing or tampography. Because of the use a pad that is soft and has high shape followability, it is preferable to use the pad printing method to perform printing on the side surface 9 of the recess 7. There are no particular limitations on the order of printing of the first printed layer 31 and the second printed layer 32.

As shown in FIG. 23, printing may be performed individually on the flat portion, not formed with the recess 7, of the second major surface 5, the flat bottom surface 8 of the recess 7, and the side surface 9 having a curved surface shape of the recess 7. In this case, a first printed layer 31 is formed on the flat portion, not formed with the recess 7, of the second major surface 5 by the screen printing method or the like. A second printed layer 32 is formed on the bottom surface 8 of the recess 7 by the screen printing method or the like. A third printed layer 33 is formed on the side surface 9 of the recess 7 by the pad printing method. So that no printed layer is formed on the bottom surface 8 by the pad printing, a cylindrical pad is used that does not have a portion corresponding to the bottom surface 8. By performing printing on the bottom surface 8 and the side surface 9 of the recess 7 separately in this manner, the thickness and the flatness of the second printed layer 32 to be formed on the bottom surface 8 can be controlled correctly. As a result, in the case where a fingerprint authentication sensor is disposed on the bottom surface 8 of the recess 7, the sensor sensitivity can be increased. There are no limitations on the order of printing of the first printed layer 31 to the third printed layer 33. When the colors or textures of printing are changed from each other between the first printed layer 31, the second printed layer 32, and the third printed layer 33, the position of a sensor 40 is made easy to be recognized visually and an accent in design can be provided. For example, where the printing is performed such that the first printed layer 31 and the second printed layer 32 have the same color and the third printed layer 33 has another color, a design that the third printed layer 33 is recognized as a ring-shaped pattern can be obtained.

The printing method for flat portions such as the portion, not formed with the recess 7, of the second major surface 5 and the flat bottom surface 8 of the recess 7 is not limited to the screen printing method and may be a printing method capable of controlling the thickness or the like of a printed layer correctly. Examples of usable printing methods include a rotary screen printing method, a letterpress printing method, an offset printing method, spray printing method, and a film transfer method. Other printing methods such as an electrostatic copying method, a thermal transfer method, and an inkjet method may also be employed.

In the case where the bottom surface 8 of the recess 7 has a curved surface shape, for example, the bottom surface 8 of the recess 7 has such a shape so as to project more in the Z direction as the position goes toward its center as shown in FIG. 6, it is preferable to perform printing on the bottom surface 8 by the pad printing method.

The printing method for a curved surface shape is not limited to the pad printing method as long as the followability to the curved surface shape is high; for example, the spray printing method may be employed.

Where the recess 7 is formed in the back surface (second major surface 5) of the cover member 1 and a display panel is disposed in the recess 7, printing may be performed only on the second-major-surface-side surface 19 of the thick portion 17 without forming a printed layer in the recess 7. In this case, interconnections etc. of the display panel are not seen from the side of the first-major-surface-side surface 18 of the cover member 1, whereby good appearance is obtained.

### (Glass Composition)

For example, as the cover member 1 and the glass substrate 101, any one of glasses described below as items (i) to (vii) can be exemplified. Glass compositions of (i) to (v) below are expressed in mol % in terms of oxides and glass compositions of (vi) to (vii) are expressed in mass % in terms of oxides.

(i) Glass including 50% to 80% of SiO₂, 2% to 25% of Al₂O₃, 0% to 10% of Li₂O, 0% to 18% of Na₂O, 0% to 10% of K₂O, 0% to 15% of MgO, 0% to 5% of CaO, and 0% to 5% of ZrO₂.

(ii) Glass including 50% to 74% of SiO₂, 1% to 10% of Al₂O₃, 6% to 14% of Na₂O, 3% to 11% of K₂O, 2% to 15% of MgO, 0% to 6% of CaO, and 0% to 5% of ZrO₂, in which the total content of SiO₂ and Al₂O₃ is 75% or smaller, the total content of Na₂O and K₂O is 12% to 25%, and the total content of MgO and CaO is 7% to 15%.

(iii) Glass including 68% to 80% of SiO₂, 4% to 10% of Al₂O₃, 5% to 15% of Na₂O, 0% to 1% of K₂O, 4% to 15% of MgO, and 0% to 1% of ZrO₂, in which the total content of SiO₂ and Al₂O₃ is 80% or smaller.

(iv) Glass including 67% to 75% of SiO₂, 0% to 4% of Al₂O₃, 7% to 15% of Na₂O, 1% to 9% of K₂O, 6% to 14% of MgO, 0% to 1% of CaO, and 0% to 1.5% of ZrO₂, in which the total content of SiO₂ and Al₂O₃ is 71% to 75% and the total content of Na₂O and K₂O is 12% to 20%.

(v) Glass including 60% to 75% of SiO₂, 0.5% to 8% of Al₂O₃, 10% to 18% of Na₂O, 0% to 5% of K₂O, 6% to 15% of MgO, and 0% to 8% of CaO.

(vi) Glass including 63% to 75% of SiO₂, 3% to 12% of Al₂O₃, 3% to 10% of MgO, 0.5% to 10% of CaO, 0% to 3% of SrO, 0% to 3% of BaO, 10% to 18% of Na₂O, 0% to 8% of K₂O, 0% to 3% of ZrO₂, and 0.005% to 0.25% of Fe₂O₃, in which R₂O/Al₂O₃ (in this formula, R₂O is Na₂O+K₂O) is 2.0 or larger and 4.6 or smaller.

(vii) Glass including 66% to 75% of SiO₂, 0% to 3% of Al₂O₃, 1% to 9% of MgO, 1% to 12% of CaO, 10% to 16% of Na₂O, and 0% to 5% of K₂O.

### EXAMPLES

Chemical strengthening was simulated under various sets of conditions and the thin portion 13 and the thick portion 17 were compared with each other in strength. A specific procedure is as follows. The present invention is not limited to the following Examples.

### Cover Member

### Example 1

A rectangular sheet-like member having the thickness in the Z direction (thickness) of 0.7 mm and major surfaces measuring 70 mm×150 mm was assumed as a glass base member. A cover member 1 was assumed to be obtained by forming a recess 7 in this glass member such that the thickness of the thin portion 13 in the Z direction was 0.3 mm (smaller than or equal to ½ and larger than or equal to ¼ of the thickness of the thick portion 17) (such that the thickness of the thick portion was 0.7 mm). Referring to (B) of FIG. 2, the width B_{y} in the Y direction and the width Bₓ in the X direction of the bottom surface 8 were 17 mm and 6 mm, respectively, and the width Sₓ in the X direction and the width S_{y} in the Y direction of the side surface 9 were 0 mm. The glass composition was set so as to correspond to the glass composition of Dragontrail (registered trademark) produced by AGC Inc.

### Example 2

A glass member was assumed that was the same as in Example 1 except that the thicknesses of the thick portion 17 was 0.7 mm and the thicknesses of the thin portion 13 in the Z direction was 0.15 mm (smaller than or equal to ¼ and larger than or equal to ⅕ of the thickness of the thick portion 17).

### Example 3

A glass member was assumed in which the thicknesses of the thick portion 17 and the thin portion were changed from those in Example 2 while the thickness ratio between them was set approximately the same as in Example 2. More specifically, a glass member was assumed that was the same as the glass member of Example 1 except that the thickness of the thick portion 17 in the Z direction was 2.1 mm and the thickness of the thin portion 13 in the Z direction was 0.45 mm (smaller than or equal to ¼ and larger than or equal to ⅕ of the thickness of the thick portion 17).

### Example 4

A glass member was assumed that was the same as the glass member of Example 1 except that the thickness of the thick portion 17 in the Z direction was 2.1 mm and the thickness of the thin portion 13 in the Z direction was 0.15 mm (smaller than ⅕ of the thickness of the thick portion 17).

Chemical strengthening was performed on the cover members of Examples 1 and 2 using a chemical strengthening simulation model described below.

### (Chemical Strengthening Simulations)

To perform chemical strengthening simulations, general structural analysis software “Abaqus” (Verb. 13-2) was used. A non-steady-state calculation was performed using Abaqus heat conduction analysis in which “a potassium ion concentration distribution” was regarded as “a temperature distribution”. The calculation was performed by applying Equations (1) and (2) to the simulations and using material coefficients for a potassium nitrate 100 mol % molten salt at 425° C. shown in Table 1.

$$\begin{matrix} ( Math . 1 ) & \\ {C}_{x} = {C}_{0} + ( {C}_{eq} - {C}_{0} ) \{ erfc \frac{x}{2 \sqrt{D t}} - exp ( \frac{H}{D} x + \frac{{H}^{2}}{D} t ) erfc \{ \frac{x}{2 \sqrt{Dt}} + \frac{H}{D} \sqrt{Dt} ) \} & ( 1 )\end{matrix}$$

In Equation (1), Cₓ is the potassium ion concentration (mol %), Co is the initial potassium ion concentration (mol %), C_{eq} is the equilibrium potassium ion concentration (mol %), D is the diffusion coefficient (m²/s) of potassium ions, H is the mass transfer coefficient (m/s) of potassium ions, t is the time (s), and x is the depth (m) from the glass surface.

$$\begin{matrix}( Math . 2 ) & \\ {σ}_{x} = - \frac{B E}{1 - ν} ( {C}_{x} - {C}_{avg} ) & ( 2 )\end{matrix}$$

In Equation (2), σₓ is the stress (Pa), B is the expansion coefficient, E is Young's modulus (Pa), v is Poisson's ratio, and C_{avg} is the average potassium concentration (mol %) given by Equation (3).

$$\begin{matrix}( Math . 3 ) & \\ {C}_{aνg} = \frac{1}{L} {\int }_{0}^{L} {C}_{x} d x & ( 3 )\end{matrix}$$

In Equation (3), L is the half thickness (m) and x is the depth (m) from the glass surface.

TABLE 1

| | | Material | |
|---|---|---|---|
| Material constant name | Symbol | constant | Unit |
| Initial potassium ion concentration | C₀ | 3.97 | mol % |
| Equilibrium potassium ion concentration | C_{eq} | 13.6 | mol % |
| Diffusion coefficient | D | 1.68 × 10⁻⁸ | m²/s |
| Mass transfer coefficient | H | 1.20 × 10⁻⁵ | m/s |
| Expansion coefficient | B | 1.06 × 10⁻³ | — |
| Young's modulus | E | 7.40 × 10¹⁰ | N/m² |
| Poisson's ratio | ν | 0.22 | — |

The chemical strengthening time was set at about 100 hours at the maximum, and integral values S, surface compressive stresses CS, and maximum values CTₘₐₓ of internal tensile stress when the chemical strengthening time was 30, 70, 150, 260, 420, 900, and 1,740 minutes were calculated according to Equations (1) to (3). Measurement positions were the center of gravity of the thin portion for the thin portion 13 and the center of gravity of the entire glass sheet for the thick portion 17. Initial values were as follows:

S=0 (MPa·mm)

CS=0 (MPa)

CTₘₐₓ=0 (MPa)

CS at a certain time t₁ was calculated by Abaqus by entering x=0 and t=t₁ in Equation (1).

CTₘₐₓ was defined as the maximum value of stress calculation values at respective nodes in the thickness direction.

S was calculated by trapezoid-approximating an integral value of a principal stress difference at each node in the thickness direction.

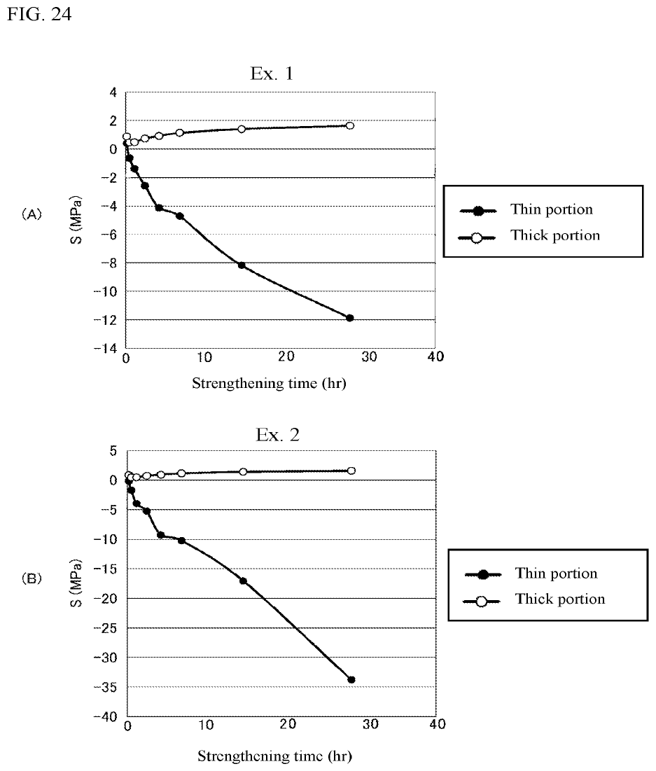

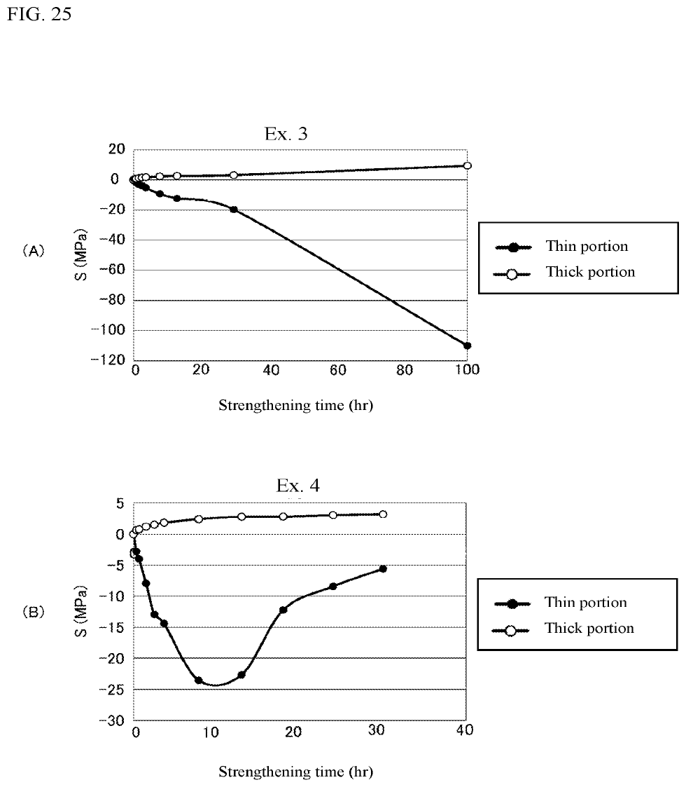

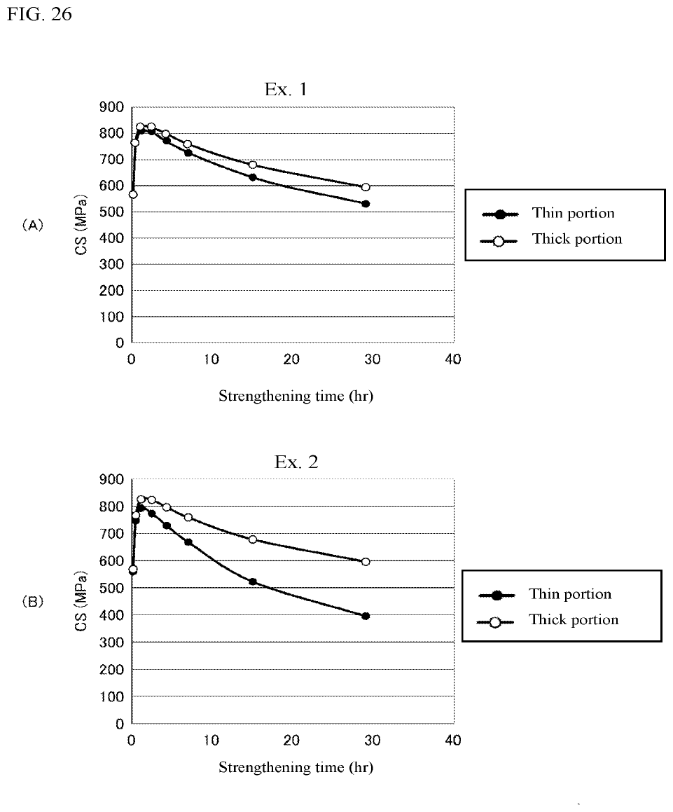

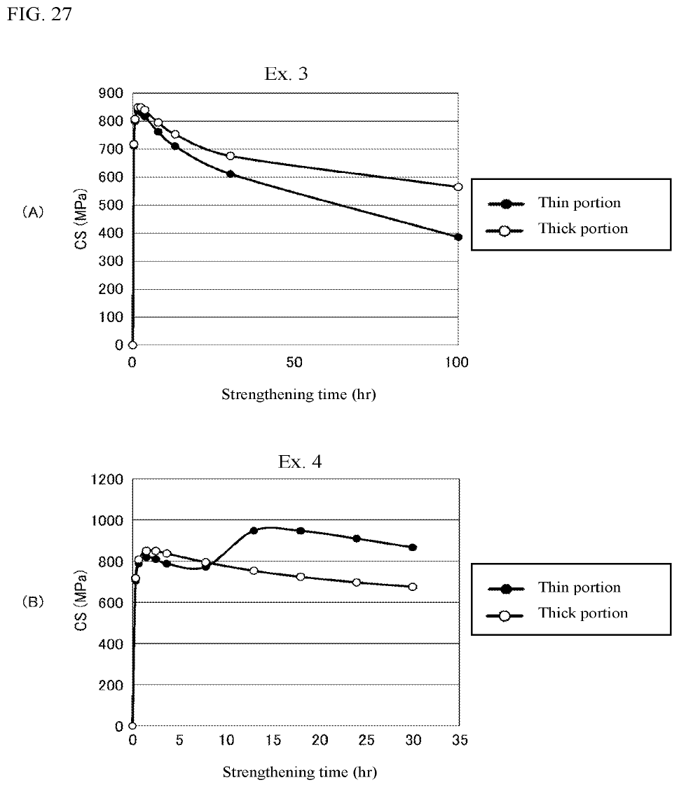

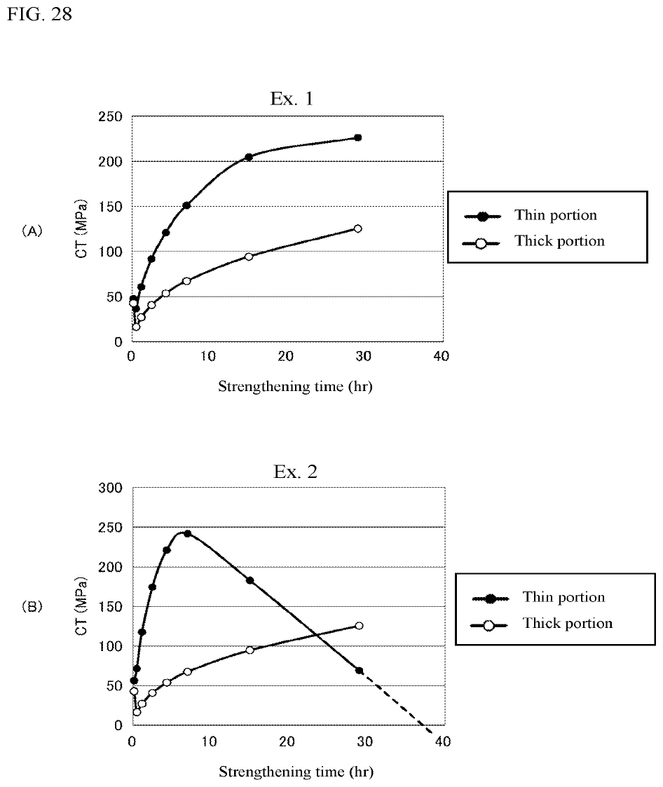

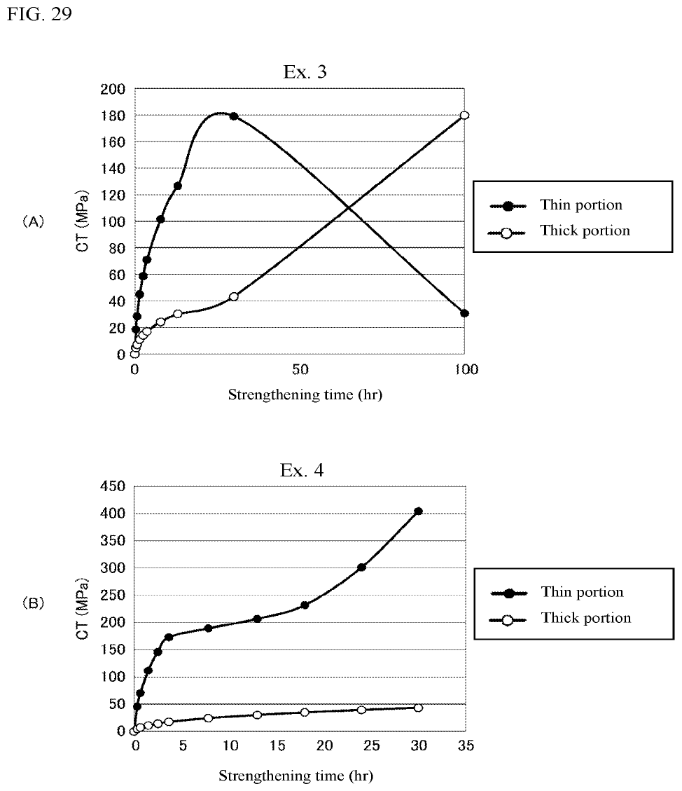

(A) and (B) of FIG. 24 show relationships between the chemical strengthening time and the integral value S in Examples 1 and 2, respectively. (A) and (B) of FIG. 25 show relationships between the chemical strengthening time and the integral value S in Examples 3 and 4, respectively. (A) and (B) of FIG. 26 show relationships between the chemical strengthening time and the surface compressive stresses CS in Examples 1 and 2, respectively. (A) and (B) of FIG. 27 show relationships between the chemical strengthening time and the surface compressive stresses CS in Examples 3 and 4, respectively. (A) and (B) of FIG. 28 show relationships between the chemical strengthening time and the internal tensile stress CT in Examples 1 and 2, respectively. (A) and (B) of FIG. 29 show relationships between the chemical strengthening time and the internal tensile stress CT in Examples 3 and 4, respectively.

As shown in (A) and (B) of FIG. 24 and (A) and (B) of FIG. 25, the integral value S in the thick portion 17 was positive and did not vary much as the chemical strengthening time elapsed. The difference in the thickness of the thin portion 13 did not cause a much difference.

On the other hand, in Examples 1, 2, and 3, the integral value S in the thin portion 13 became negative immediately after the start of the chemical strengthening and the absolute value of the negative value increased greatly as the chemical strengthening time elapsed. The absolute value of the integral value S was larger when the thin portion 13 was thinner. In Example 4, the integral value S became negative immediately after the start of the chemical strengthening. As the chemical strengthening time elapsed further, the integral value S came to have negative values that were close to 0 because of buckling by a load due to compressive stress generated during the chemical strengthening. However, in all of Examples 1 to 4, the absolute value of the integral value S was smaller than 0 MPa and was made smaller than −10 MPa, even −20 MPa, by a control such as increasing the chemical strengthening time.

It was found from the above results that the integral value S in the thin portion 13 can be controlled so as to be smaller than 0 MPa by a chemical strengthening. It was suggested that in Examples 1 to 3 (the thickness of the thin portion 13 is smaller than or equal to ½ and larger than or equal to ⅕ of the thickness of the thick portion 17), the integral value S decreases monotonously as the chemical strengthening time elapses and hence a strict control of the integral value S can be performed more easily than in Example 4.

As shown in (A) and (B) of FIG. 26, and (A) of FIG. 27, in Examples 1, 2, and 3, CS in each of the thick portion 17 and the thin portion 13 increased immediately after the start of the chemical strengthening but decreased thereafter gently. While CS varied in this manner, CS in the thick portion 17 was always larger than CS in the thin portion 13. On the other hand, in Example 4, as shown in (B) of FIG. 27, whereas CS in the thick portion 17 varied in the same manner as in Examples 1, 2, and 3, CS in the thin portion 13 decreased after the start of the chemical strengthening, then turned to increase due to buckling so as to exceed the values in the thick portion 17, and thereafter decreased again.

CS was always larger than or equal to 300 MPa in both of the thin portion 13 and the thick portion 17.

From the above results, it was found that the surface compressive stress CS in the thick portion 17 can be controlled so as to be larger than the surface compressive stress CS in the thin portion 13 by a chemical strengthening when the thickness of the thin portion 13 is at least smaller than or equal to ½ of the thickness of the thick portion 17.

It was also found that to make the surface compressive stress CS in the thick portion 17 always larger than the surface compressive stress CS in the thin portion 13, Examples 1 to 3 (the thickness of the thin portion 13 is smaller than or equal to ½ and larger than or equal to ⅕ of the thickness of the thick portion 17) are preferable.

As shown in (A) of FIG. 28, in Example 1, the internal tensile stress CT increased immediately after the start of the chemical strengthening in each of the thick portion 17 and the thin portion 13 but the internal tensile stress CT in the thin portion 13 was larger than the internal tensile stress CT in the thick portion 17.

On the other hand, in Example 2, as shown in (B) of FIG. 28, whereas the internal tensile stress CT in the thin portion 13 was larger than the internal tensile stress CT in the thick portion 17 until the chemical strengthening time reached 23 hours, the internal tensile stress CT in the thin portion 13 became equal to the internal tensile stress CT in the thick portion 17 when the chemical strengthening time was 23 hours. When the chemical strengthening time was longer than 23 hours, the internal tensile stress CT in the thin portion 13 was smaller than the internal tensile stress CT in the thick portion 17. The internal tensile stress CT in the thin portion 13 was larger than or equal to 50 MPa while the chemical strengthening time was shorter than 30 hours. The internal tensile stress CT in the thick portion 17 was larger than or equal to 50 MPa when the chemical strengthening time was longer than 5 hours.

Furthermore, in Example 2, as shown in (B) of FIG. 28, the internal tensile stress CT in the thin portion 13 decreased monotonously after the chemical strengthening time exceeded 5 hours and hence it was expected that the internal tensile stress CT in the thin portion 13 would turn negative (stress is smaller than 0 MPa) at a certain time point around the chemical strengthening time of 38 hours (indicated by a broken line).

As shown in (A) of FIG. 29, in Example 3, the relationship between the chemical strengthening time and the internal tensile stress CT was similar to that in Example 2. More specifically, whereas the internal tensile stress CT in the thick portion 17 increased as the time elapsed, the internal tensile stress CT in the thin portion 13 increased immediately after the start of the chemical strengthening and then decreased. This suggested that a similar tendency is obtained even if the thick portion 17 and the thin portion 13 are different from each other in thickness as long as their thickness ratio is the same.

As shown in (B) of FIG. 29, the relationship between the chemical strengthening time and the internal tensile stress CT in Example 4 was different from that of each of Examples 1 to 3. More specifically, the internal tensile stress CT in the thick portion 17 showed almost no increase and the internal tensile stress CT in the thin portion 13 continued to increase even when the chemical strengthening time become long.

It was found from the above results that it is possible to make the internal tensile stress CT in the thin portion 13 larger than or smaller than the internal tensile stress CT in the thick portion 17 by adjusting the thickness of the thin portion 13 and the chemical strengthening time.

It was also found from the results of Examples 2 and 3 that the internal tensile stress CT in the thin portion 13 may be able to be smaller than the internal tensile stress CT in the thick portion 17 if the thickness of the thin portion 13 is smaller than or equal to ¼ and larger than or equal to ⅕ of the thickness of the thick portion 17.

It was found from the above results that it is possible to control the stress so as to be smaller than 0 MPa at an arbitrary point in a cross section of the thin portion 13 by adjusting the thickness of the thin portion 13 and the chemical strengthening time. It was also found that the surface compressive stress CS in the thick portion 17 can be made larger than the surface compressive stress CS in the thin portion 13. Furthermore, it was found that the internal tensile stress CT can be controlled so as to be larger than or equal to 50 MPa or smaller than or equal to 50 MPa in each of the thin portion 13 and the thick portion 17 by controlling the chemical strengthening time.

It was found that the relationships between the chemical strengthening time and the surface compressive stress CS, internal tensile stress CT, and integral value S are varied by changing the thickness ratio between the thin portion 13 and the thick portion 17.

### (Modifications)

The present invention is not limited to only the above embodiment and various improvements, design changes, etc. are possible without departing from the gist of the present invention. Furthermore, the specific procedure, structure, etc. that are employed in practicing the present invention may be changed within the scope that the object of the present invention can be attained.

### (Cover Member Having a Bent Portion)

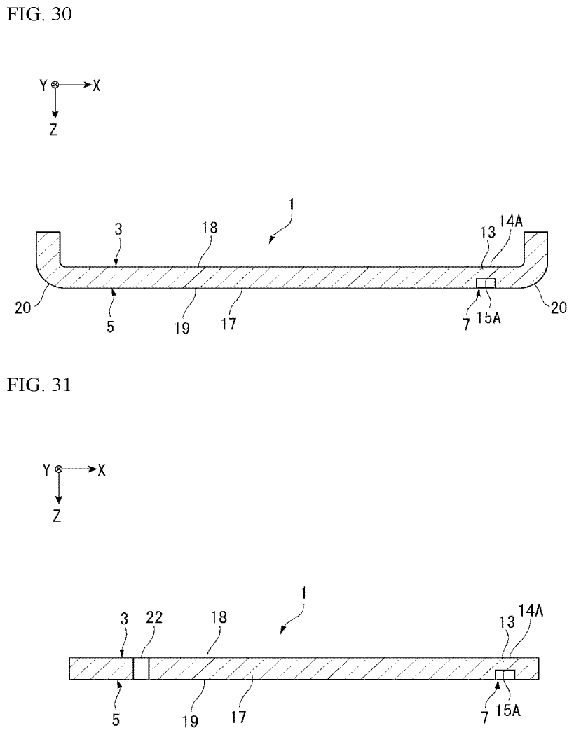

As shown in FIG. 30, the cover member 1 may have at least one bent portion 20. Example shapes include a shape that is a combination of the bent portion 20 and a flat portion and a shape that the bent portion 20 constitutes the entire cover member. There are no particular limitations on the shape of the cover member as long as it has the bent portion 20. In recent years, in the case where a cover member having a bent portion 20 is used for a display device, various kinds of apparatus (television, personal computer, smartphone, car navigation apparatus, etc.) whose screen of a display panel is a curved surface have appeared. The bent portion 20 can be formed so as to conform to the shape of a display panel or the shape of a body of a display panel. The term “flat portion” means a portion whose average radius of curvature is longer than 1,000 mm and the term “bent portion” means a portion whose average radius of curvature is shorter than or equal to 1,000 mm.

### (Cover Member Having a Through-Hole)

As shown in FIG. 31, the cover member 1 may have at least one through-hole in a thick portion 17.

The number, shape, etc. of a through-hole(s) 22 may be determined in desired manners.

Where the cover member 1 has the through-hole 22, even if a connector for connection to the outside such as an earphone jack is exposed from a protection target surface to which the cover member 1 is to be attached, the cover member can be attached to the protection target surface without covering the connector.

(Cover Member Both Surfaces of which are Formed with a Recess)

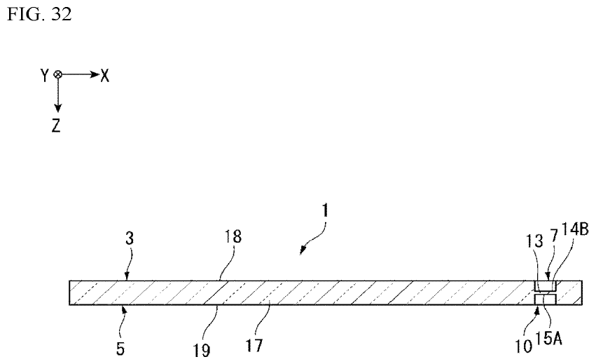

As shown in FIG. 32, both surfaces of the cover member 1 may be formed with recesses. More specifically, each of the first major surface 3 and the second major surface 5 of the cover member 1 may be formed with one recess 7 and 10. The recesses 7 and 10 are formed in the vicinity of one end of the cover member 1 in the X direction and in the vicinity of its center line in the Y direction. Each of the recesses 7 and 10 is formed so as to have an elongated circle shape that is longer in the Y direction than in the X direction when viewed from the +Z direction or the −Z direction.

The recesses 7 and 10 may be formed at any position as long as they are opposed to each other in the Z direction (i.e., the recesses 7 and 10 coextend in XY planes, that is, they are superimposed on each other in a plan view). To make the positional deviation between the recesses 7 and 10 not conspicuous, it is preferable that the distance in a plan view of the cover member 1 between the center of gravity of the recess 7 and the center of gravity of the recess 10 is 100 μm or shorter. The number, shape, etc. of recesses 7 and 10 may be determined in desired manners.

### (Surface Roughness Etc.)

The roughness of a first bottom surface portion and a second bottom surface portion of the thin portion 13 and a first major surface and a second major surface of the printed layer of the cover member 1 is not limited to the above-described arithmetic mean roughness Ra. In the case of the root-mean-square roughness Rq, it is preferable that Rq is 0.3 nm or larger and 100 nm or smaller. If Rq is 100 nm or smaller, roughness is less likely felt. If Rq is 0.3 nm or larger, the friction coefficient of the glass surface is made proper and the slidability of a finger or the like is improved. In the case of the maximum height roughness Rz, it is preferable that Rz is 0.5 nm or larger and 300 nm or smaller. If Rz is 300 nm or smaller, roughness is less likely felt. If Rz is 0.5 nm or larger, the friction coefficient of the glass surface is made proper and the slidability of a finger or the like is improved.

In the case of the maximum sectional height roughness Rt, it is preferable that Rt is 1 nm or larger and 500 nm or smaller. If Rt is 500 nm or smaller, roughness is less likely felt. If Rt is 1 nm or larger, the friction coefficient of the glass surface is made proper and the slidability of a finger or the like is improved. In the case of the maximum peak height Rp, it is preferable that Rp is 0.3 nm or larger and 500 nm or smaller. If Rp is 500 nm or smaller, roughness is less likely felt. If Rp is 0.3 nm or larger, the friction coefficient of the glass surface is made proper and the slidability of a finger or the like is improved. In the case of the maximum root depth Rv, it is preferable that Rv is 0.3 nm or larger and 500 nm or smaller. If Rv is 500 nm or smaller, roughness is less likely felt. If Rv is 0.3 nm or larger, the friction coefficient of the glass surface is made proper and the slidability of a finger or the like is improved.

In the case of the average length roughness Rsm, it is preferable that Rsm is 0.3 nm or larger and 1,000 nm or smaller. If Rsm is 1,000 nm or smaller, roughness is less likely felt. If Rsm is 0.3 nm or larger, the friction coefficient of the glass surface is made proper and the slidability of a finger or the like is improved. In the case of the kurtosis roughness Rku, it is preferable that Rku is 1 or larger and 3 or smaller. If Rku is 3 or smaller, roughness is less likely felt. If Rku is 1 or larger, the friction coefficient of the glass surface is made proper and the slidability of a finger or the like is improved. Other parameters such as Wa that represent undulation can be employed, and there are no particular limitations on the parameter to represent roughness. Where skewness roughness Rsk is employed, it is preferable that Rsk is −1 or larger and 1 or smaller from the viewpoint of the uniformity of visibility, tactility etc.

### (Uses)

There are no particular limitations on the use of the cover member according to the present invention. Specific examples include vehicular transparent components (e.g., headlight cover, side mirror, front transparent substrate, side transparent substrate, rear transparent substrate, and instrument panel surface), meters, construction windows, show windows, construction interior members, construction exterior members, displays (e.g., notebook personal computer, monitor, LCD, PDP, ELD, CRT, and PDA), LCD color filters, touch panel substrates, pickup lenses, optical lenses, lenses for glasses, camera components, video components, CCD cover substrates, optical fiber end surfaces, projector components, copier components, solar cell transparent substrates (e.g., cover member), cellphone windows, backlight unit components (e.g., light guide plate and cold cathode tube), backlight unit component liquid crystal luminance increasing films (e.g., prism and semitransparent film), liquid crystal luminance increasing films, organic EL light-emitting element components, inorganic EL light-emitting element components, phosphor light-emitting element components, optical filters, optical component end surfaces, illumination lamps, illumination equipment covers, amplifier laser light sources, antireflection films, polarizing films, and agricultural films.

### (Article)

An article according to the present invention includes the cover member 1.

The article according to the present invention may either consist of only the cover member 1 or include a member(s) other than the cover member 1.

Examples of the article according to the present invention include the ones that were mentioned above as uses of the cover member 1, and devices having one or more of those examples.

Example devices include a personal data assistance, a display device, an illumination device, and a solar cell module.

The article according to the present invention has the recess 7, is high in the sensitivity of sensing and visibility, and hence is suitable for use in a personal data assistance and a display device. The cover member 1 for uses in a vehicle is required to have plural large recesses 7, and is required to provide high sensitivity of sensing when a sensor is disposed to it. There may occur a case that a cover member 1 having a bent shape is required to be formed with a recess 7. The present invention can provide cover members 1 capable of satisfying these requirements. As such, the cover member 1 according to the present invention is suitable for use as a vehicular cover member 1.

Where the article according to the present invention is a display device, the article according to the present invention includes a display panel for displaying an image and a cover member 1 according to the present invention which is disposed on the viewing side of a display device main body.

Examples of the display panel include a liquid crystal panel, an organic EL (electroluminescence) panel, and a plasma display panel. The cover member 1 may be integrated with the display panel as a protective sheet for the display device, or a structure in which a sensor such as a touch panel sensor is disposed on a second major surface 5 of the display panel, that is, a display panel is disposed between the cover member 1 and the sensor may be employed. Alternatively, the cover member 1 may be disposed on the viewing side of the display panel via a sensor.

The present invention can provide a cover member capable of exhibiting a desired sensing ability when a fingerprint authentication sensor is incorporated in it, and can provide a personal data assistance including the cover member.

The present application is based on Japanese Patent Application No. 2017-173852 filed on Sep. 11, 2017, the disclosure of which is incorporated herein by reference.

### REFERENCE SIGNS LIST

1 . . . Cover member
3 . . . First major surface
5 . . . Second major surface
7 . . . Recess
13 . . . Thin portion
17 . . . Thick portion
20 . . . Bent portion
22 . . . Through-hole

1. A cover member which serves to protect a protection target and comprises a chemically strengthened glass, integrally comprising:
a first major surface and a second major surface;
at least one recess formed in at least one of the first major surface and the second major surface; and
a thin portion formed by the recess, and a thick portion connected to the thin portion, wherein
the cover member has an integral value S of a principal stress difference being smaller than 0 MPa in a thickness direction of the thin portion at a center of gravity of the thin portion, in a case where a tensile stress and a compressive stress are regarded as positive and negative, respectively.

2. The cover member according to claim 1, wherein the integral value S of the principal stress difference in the thickness direction of the thin portion is smaller than −10 MPa.

3. The cover member according to claim 1, wherein:
the thick portion has a surface compressive stress CS of larger than a surface compressive stress CS in the thin portion; and
the thin portion has a thickness of smaller than or equal to ½ of a thickness of the thick portion.

4. The cover member according to claim 3, wherein each of the surface compressive stress CS in the thin portion and the surface compressive stress CS in the thick portion is 300 MPa or larger.

5. The cover member according to claim 1, wherein the thin portion has an internal tensile stress CT of larger than an internal tensile stress CT in the thick portion.

6. The cover member according to claim 5, wherein the internal tensile stress CT in the thin portion is 50 MPa or larger and the internal tensile stress CT in the thick portion is 50 MPa or smaller.

7. The cover member according to claim 1, wherein the thick portion has the internal tensile stress CT of larger than the internal tensile stress CT in the thin portion.

8. The cover member according to claim 7, wherein the internal tensile stress CT in the thick portion is 50 MPa or larger and the internal tensile stress CT in the thin portion is 50 MPa or smaller.

9. The cover member according to claim 1, wherein the thin portion has the internal tensile stress CT of smaller than 0 MPa at an arbitrary point in a cross section of the thin portion.

10. The cover member according to claim 1, wherein at least a part of the thick portion has a bent portion.

11. The cover member according to claim 1, wherein at least a part of the thick portion has a through-hole.

12. The cover member according to claim 11, wherein the protection target is a personal data assistance.

13. A personal data assistance comprising the cover member according to claim 1.
